(19) United States
(12) Patent Application Publication
(10) Pub. No.: US 2019/0276091 A1
(43) Pub. Date: Sep. 12, 2019

(54) VEHICLE BODY MODIFICATION SYSTEM AND METHOD

(71) Applicant: FAB FOURS INC., Lancaster, SC (US)

(72) Inventor: Gregory N. HIGGS, Charlotte, NC (US)

(73) Assignee: FAB FOURS INC., Lancaster, SC (US)

(21) Appl. No.: 15/918,558

(22) Filed: Mar. 12, 2018

(51) Int. Cl. B62D 25/18; B60R 13/04; B62D 65/16

(52) U.S. Cl. CPC B62D 25/18; B62D 65/16; B60R 13/04

(57) ABSTRACT

A vehicle body modification system includes a plurality of templates and a plurality of replacement vehicle body parts. Each template has a predetermined shape and a predetermined size. A contour of each template matches a corresponding surface contour of a vehicle body of a vehicle. Each template is configured to provide a predetermined modification instruction for modifying the vehicle body so as to form an attachment surface or edge for attaching a corresponding one of the replacement vehicle body parts.

### BACKGROUND

The present disclosure relates to a vehicle body modification system and a vehicle body modification method with which a part of a vehicle body, such as a fender, may be modified.

### SUMMARY

Modification of vehicle bodies is becoming more and more popular. One such modification is made to fenders for aesthetic as well as functional reasons, such as to accommodate tires of different sizes. Conventionally, to accommodate larger tires, one or two modifications would need to be made: (1) lift the vehicle body, or (2) enlarge the wheel wells, including the fenders. In order to achieve modification of the shape and size of a wheel well and fender (or other vehicle body portion) according to the needs of the vehicle owner, it has been necessary for a mechanic or other professional to painstakingly measure and determine, by trial and error, which areas of the vehicle body to cut or otherwise modify, and to find or manufacture the necessary replacement parts that would form the modified wheel well and fender. As a result, much time and expense has been required to modify vehicle wheel wells and fenders to accommodate large tires.

Exemplary embodiments of the broad inventive principles described herein address the aforementioned problems by providing a vehicle body modification system and a vehicle body modification method that circumvent the need for a professional to measure and determine which areas of the fender to cut, as well as the need to find or manufacture the necessary replacement parts that would form the modified vehicle fender. Thus, the vehicle body modification system and method of this disclosure greatly reduce the time and cost associated with preparing for and performing a vehicle body modification.

It should be understood that the following disclosure is not limited to any particular vehicle model or shape. Rather, there are many different vehicle models and vehicle body shapes to which and for which this disclosure may be applied. As one non-limiting example, the following disclosure will discuss the disclosed embodiments as applied to a vehicle body modification system and method for a particular vehicle. However, the templates used in the system and method are not to be interpreted as limiting this disclosure, as each vehicle model and/or desired fender design may have different template shapes and sizes as needed. Also, the following disclosure will discuss the disclosed embodiments as applied to a vehicle fender system. However, the disclosed system and method are not to be interpreted as limited to fenders. The broad inventive principles described herein are widely applicable to various vehicle body portions.

The solution to the problems discussed above is a vehicle body modification system and a vehicle body modification method that provide a plurality of templates and a plurality of replacement vehicle body parts. Each template has a predetermined shape and a predetermined size. A contour of each template matches a corresponding surface contour of a vehicle body of a vehicle. Each template is configured to provide a predetermined modification instruction for modifying the vehicle body so as to form an attachment surface or edge for attaching a corresponding one of the replacement vehicle body parts.

### BRIEF DESCRIPTION OF THE DRAWINGS

FIG. 1 is a view illustrating a vehicle to which the vehicle body modification system and method have been applied.

FIG. 2 is a view illustrating one example of templates provided in the vehicle body modification system.

FIG. 3 is a view illustrating one example of mounting tabs provided for mounting front fender bases.

FIG. 4 is a view illustrating one example of mounting plates for mounting the front fender bases.

FIG. 5 is a view illustrating one example of mounting plates for mounting the front fender bases.

FIG. 6A is a view illustrating one example of a cap plate used for a driver-side vehicle rocker panel.

FIG. 6B is a view illustrating one example of a reinforcement bracket for a driver-side vehicle reinforcement bar.

FIG. 7A is a view illustrating one example of a reinforcement bracket for a passenger-side vehicle reinforcement bar.

FIG. 7B is a view illustrating one example of a cap plate used for a passenger-side vehicle rocker panel.

FIGS. 8A to 8D are views illustrating one example of fender bases.

FIG. 9A to 9D are views illustrating one example of fender flares.

FIGS. 10A and 10B are views illustrating one example of front inner fenders.

FIG. 11 is a view illustrating a fender including a mud flap prior to modification.

FIG. 12 is a view illustrating a fender including a trim prior to modification.

FIG. 13 is a view illustrating inner fender/liner screws or pins to be removed during modification.

FIG. 14 is a view illustrating inner fender retainers to be removed during modification.

FIG. 15 is a view illustrating a template DS-1 installed on a driver-side fender.

FIG. 16 is a view illustrating a template PS-3 installed on a passenger-side fender.

FIG. 17 is a view illustrating a template DS-2 installed on the driver-side fender.

FIG. 18 is a view illustrating a template PS-4 installed on the passenger-side fender.

FIG. 19 is a view illustrating a template DS-14 installed on a driver-side vehicle rocker panel.

FIG. 20 is a view illustrating a template DS-11 installed on the driver-side vehicle rocker panel.

FIG. 21 is a view illustrating the templates DS-14 and DS-11 installed on the driver-side vehicle rocker panel.

FIG. 22 is a view illustrating a template PS-7 installed on a passenger-side vehicle rocker panel.

FIG. 23 is a view illustrating a template DS-13 installed on the driver-side vehicle rocker panel.

FIG. 24A is a view illustrating templates DS-12, DS-14 and DS-11 installed on the driver-side vehicle rocker panel.

FIG. 24B is a view illustrating templates PS-6, PS-8 and PS-5 installed on the passenger-side vehicle rocker panel.

FIG. 25 is a view illustrating a template DS-15 installed on a driver-side reinforcement bar.

FIG. 26 is a view illustrating a template PS-9 installed on a passenger-side reinforcement bar.

FIG. 27 is a view illustrating a template DS-16 installed at the driver-side reinforcement bar.

FIG. 28 is a view illustrating a template PS-10 installed at the passenger-side reinforcement bar.

FIG. 29 is a view illustrating a flange of a rocker panel to be cut.

FIG. 30 is a view illustrating the rocker panel having been cut using the template PS-5.

FIG. 31 is a view illustrating the rocker panel having been cut using the template PS-6.

FIG. 32 is a view illustrating the driver-side reinforcement bar cut in the method.

FIG. 33 is a view illustrating the passenger-side reinforcement bar cut in the method.

FIG. 34 is a view illustrating the passenger-side reinforcement bar cut in the method.

FIG. 35 is a view illustrating a rear fender to be cut in the method.

FIG. 36 is a view illustrating a contour of the rear fender marked in the method.

FIG. 37 is a view illustrating the driver-side front fender cut at a front end using the template DS-2.

FIG. 38 is a view illustrating the passenger-side front fender cut at a front end using the template PS-4.

FIG. 39 is a view illustrating the driver-side front fender cut at a rear end using the template DS-1.

FIG. 40 is a view illustrating the passenger-side front fender cut at a rear end using the template PS-3.

FIG. 41 is a view illustrating the passenger-side reinforcement bar after being cut using the template PS-10.

FIG. 42 is a view illustrating the driver-side reinforcement bar after being cut using the template DS-16.

FIG. 43 is a view illustrating the driver-side reinforcement bar after being cut using the template DS-15.

FIG. 44 is a view illustrating the passenger-side reinforcement bar after being cut using the template PS-9.

FIG. 45 is a view illustrating the driver-side vehicle rocker panel after being cut using the templates DS-14 and DS-11.

FIG. 46 is a view illustrating the passenger-side vehicle rocker panel after being cut using the templates PS-8 and PS-5.

FIG. 47 is a view illustrating the vehicle rocker panel after having been cut and installed with foam.

FIG. 48 is a view illustrating a cap plate installed on the rocker panel and secured with tape.

FIG. 49 is an alternate view illustrating the cap plate installed on the rocker panel and secured with tape.

FIG. 50 is a view illustrating the cap plate installed on the rocker panel and secured with bolts.

FIG. 51 is a view illustrating the reinforcement bar after having been cut using the template PS-10.

FIG. 52 is a view illustrating the reinforcement bracket installed to the reinforcement bar.

FIG. 53 is a view illustrating the inner fender installed against the vehicle frame.

FIG. 54 is a view illustrating the front fender base prepared for installation.

FIG. 55 is a view illustrating the front fender base provided with a sealing member.

FIG. 56 is a view illustrating the front fender base with the mounting tabs and mounting plates installed thereon.

FIG. 57 is a view illustrating the vehicle before the front fender base is installed.

FIG. 58 is a view illustrating the vehicle after the front fender base is installed.

FIG. 59 is a view illustrating the rear fender base installed.

FIG. 60 is a view illustrating the front fender flare installed.

FIG. 61 is a view illustrating the rear fender flare installed.

### DETAILED DESCRIPTION OF EMBODIMENTS

The vehicle body modification system and vehicle body modification method according to the exemplary embodiments disclosed herein are described below in detail. It should be noted that the term “fender” as used herein is intended to include the part of the vehicle body that frames the wheel well of the vehicle. However, the term “fender” is not limited thereto and may also include portions of the vehicle body extending outward from the frame of the wheel well. Also, as described above, the vehicle body modification system and vehicle body modification method are applicable to vehicle body portions other than the fender. It should be further noted that the term “contour” as used herein is intended to refer to any distinguishing feature of the vehicle body, including but not limited to a surface or an edge of the vehicle body.

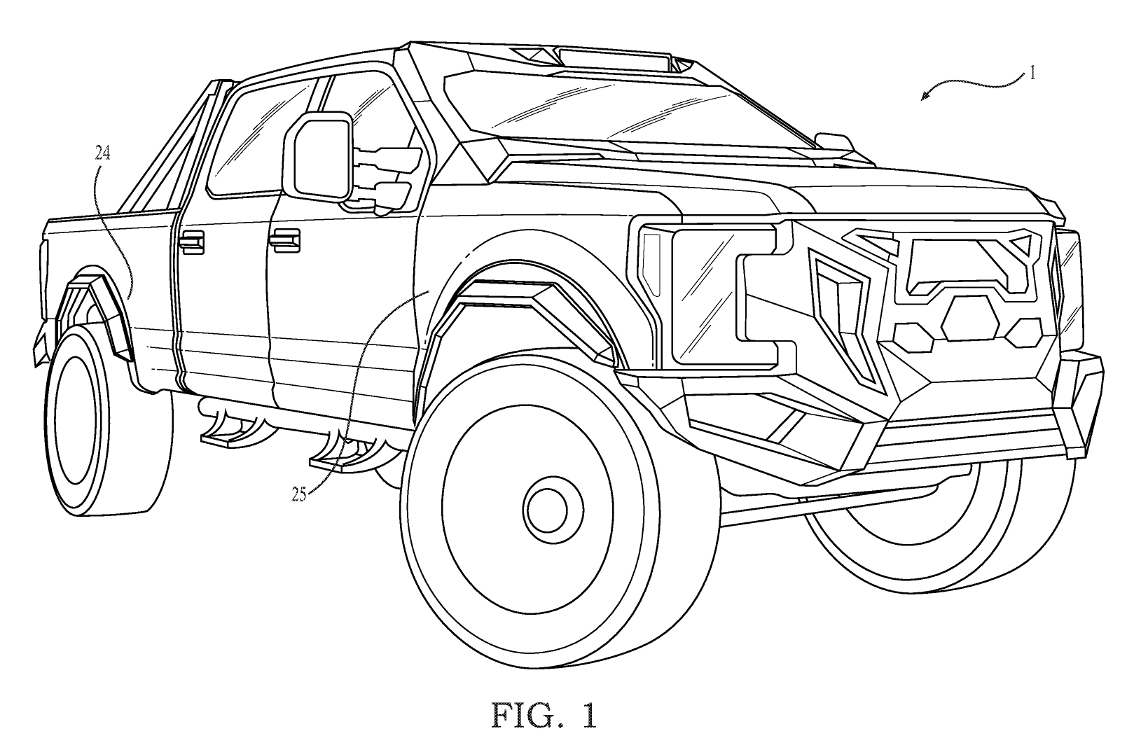

FIG. 1 shows one non-limiting example of a vehicle 1 to which the vehicle body modification system and method have been applied. The vehicle 1 of FIG. 1 includes front fenders 25 and rear fenders 24 on the driver and passenger sides.

(1) Vehicle Body Modification System

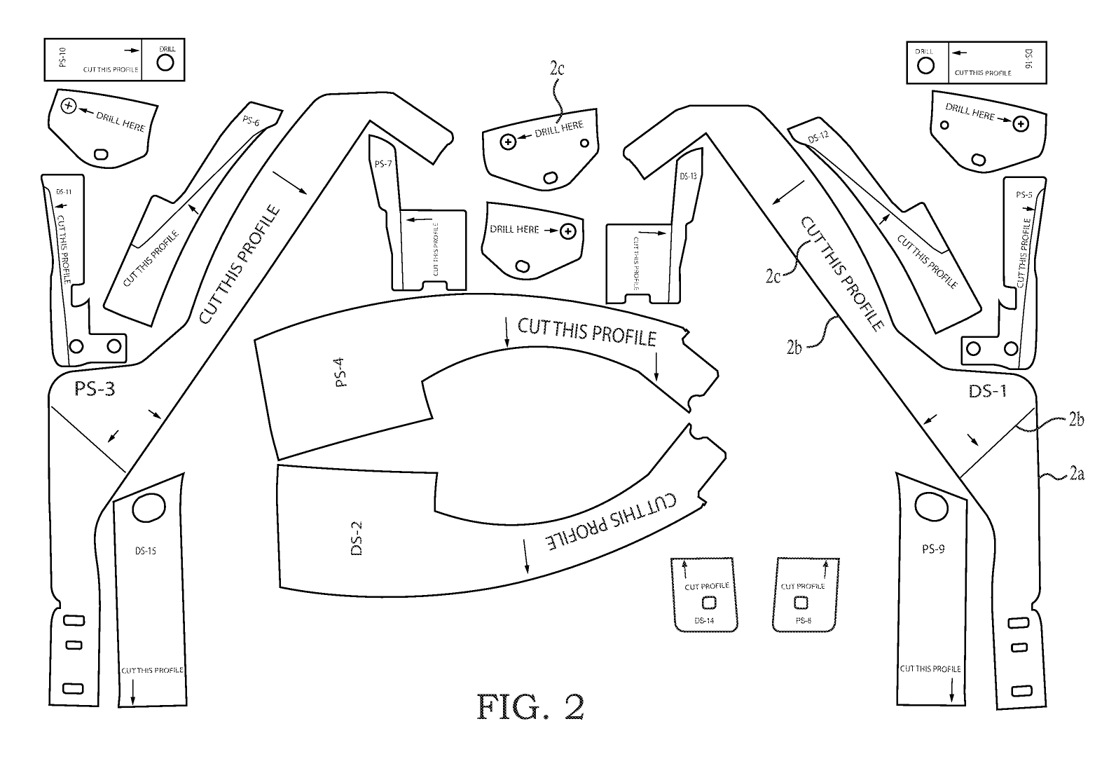

The vehicle body modification system includes a plurality of templates and a plurality of replacement vehicle body parts. FIG. 2 shows a non-limiting example of the plurality of templates that may be included in the vehicle body modification system. The notation “DS” signifies “driver side,” and the notation “PS” signifies “passenger side.” For example, the template DS-1 is a driver-side template which may be installed on the driver-side vehicle fender. In contrast, the template PS-3 shown in FIG. 2 is the passenger-side template which may be installed on the passenger-side vehicle fender. The template PS-3 is a mirror image of the template DS-1. All or substantially all of the templates for the driver side are mirror images of the templates for the passenger side.

The templates may each be configured to be attached to a respective vehicle body portion which will be cut, drilled, or otherwise modified during the fender modification. Each template may have a predetermined shape, a predetermined size, and a predetermined modification instruction displayed thereon.

The templates may be formed as stickers having adhesive for attaching to the vehicle body. However, the templates are not limited to stickers and may be made of other materials, and the templates may be attached to the vehicle body using any appropriate means of attachment. Alternatively, the templates may be formed as images projected using a projector or other image forming means by which the templates are projected onto the corresponding vehicle body portions.

The template DS-1 shown in FIG. 2 has a predetermined shape including a contour 2a and a cut profile 2b which serve to both match (align with) the surface of the corresponding vehicle body portion to which the template DS-1 is to be installed, and also to provide the cut, drill, or other modification lines for executing the modification of the fender.

The template DS-1 also has a predetermined modification instruction 2c to “cut this profile.” As will be explained in greater detail below, these templates may be employed during the vehicle body modification method to clearly indicate where and how to cut, drill, and otherwise modify the vehicle body. As a result, the vehicle body modification method is simplified and does not require a professional to measure and determine which areas of the fender or other vehicle structure to modify.

The plurality of replacement vehicle body parts are also predetermined and included in the vehicle body modification system. It should be understood that the replacement vehicle body parts are not limited to the following description of an exemplary embodiment. As mentioned above, depending on the particular vehicle model and/or the particular modification design, the replacement vehicle body parts will have different shapes, sizes, and may be excluded or added to as needed.

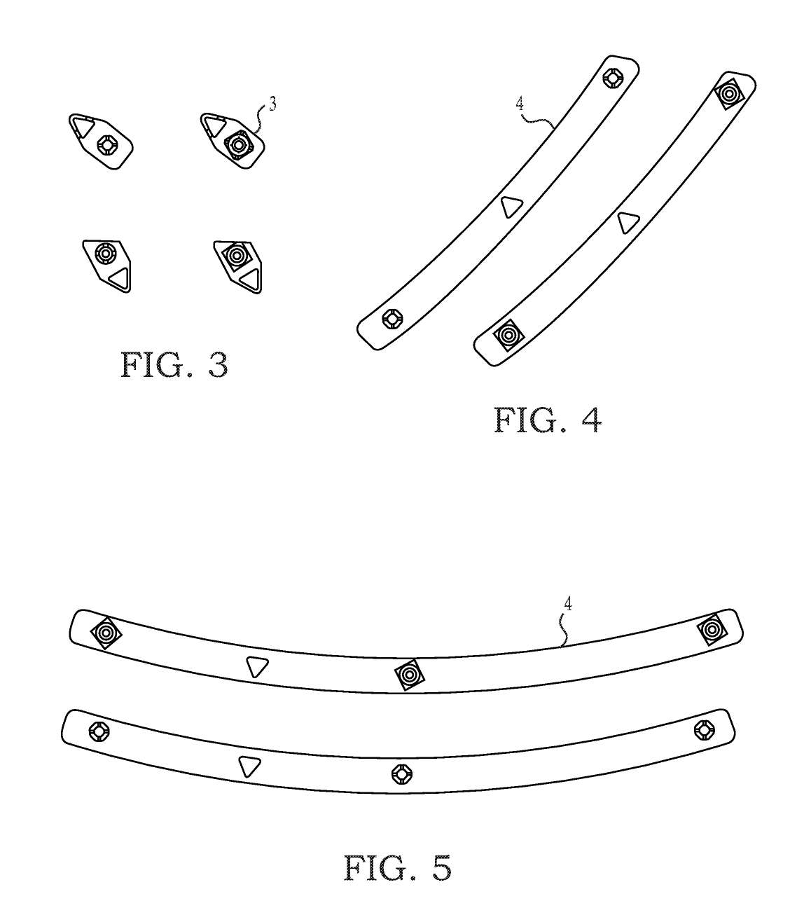

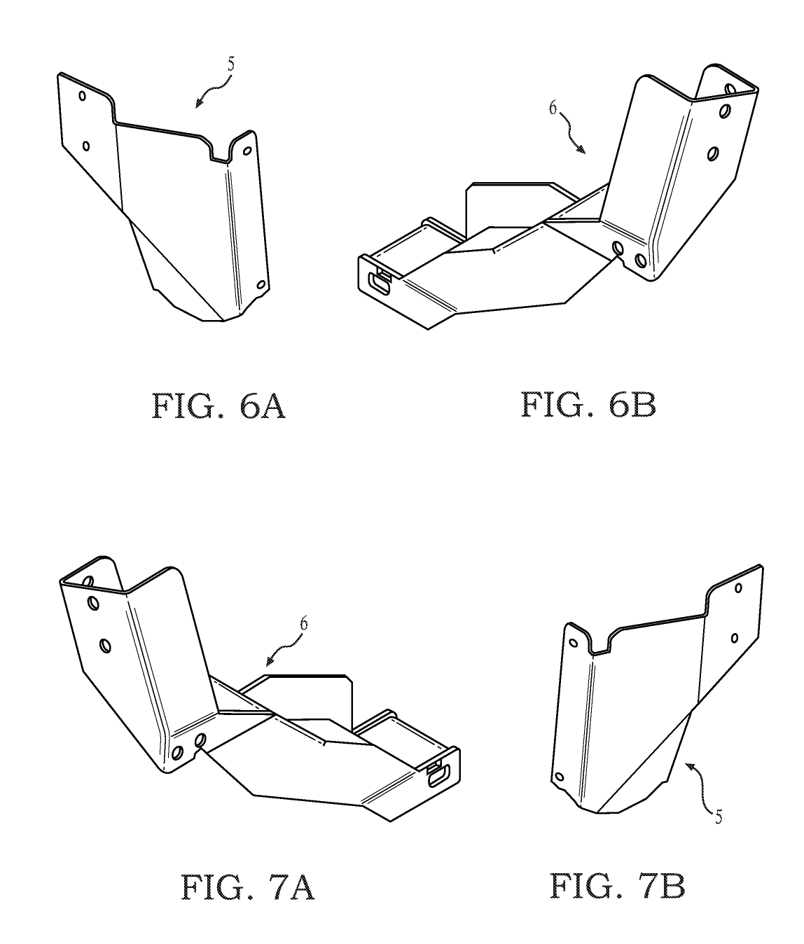

FIGS. 3 to 10B show non-limiting examples of replacement vehicle body parts that may be included in the vehicle body modification system. In particular, FIG. 3 shows one example of mounting tabs 3 provided for mounting the front fender bases. FIGS. 4 and 5 show one example of mounting plates 4 for mounting the front fender bases. FIGS. 6A and 7B show one example of cap plates 5 used for vehicle rocker panels. The cap plate 5 of FIG. 6A is for the driver side, and the cap plate 5 of FIG. 7B is for the passenger side. FIGS. 6B and 7A show one example of reinforcement brackets 6 for vehicle reinforcement bars. The reinforcement bracket 6 of FIG. 6B is for the driver side, and the reinforcement bracket 6 of FIG. 7A is for the passenger side.

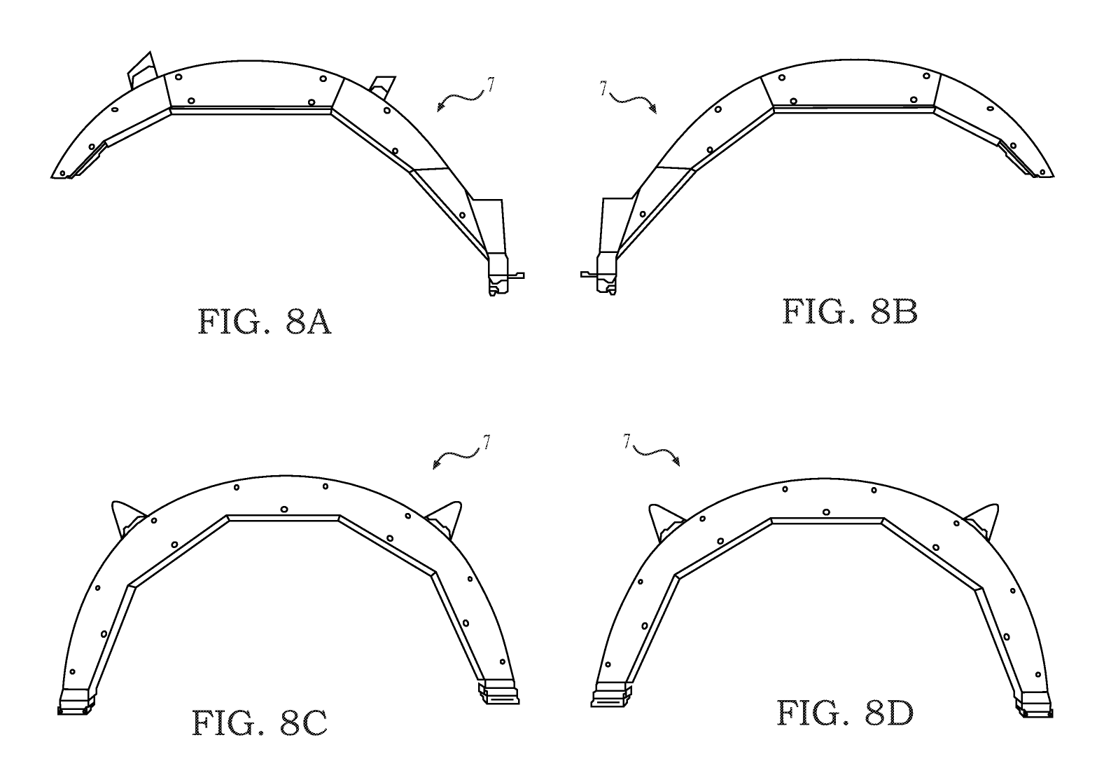

FIGS. 8A to 8D show one example of the fender bases 7. FIG. 8A shows the front driver-side fender base 7. FIG. 8B shows the front passenger-side fender base 7. FIG. 8C shows the rear driver-side fender base 7. FIG. 8D shows the rear passenger-side fender base 7.

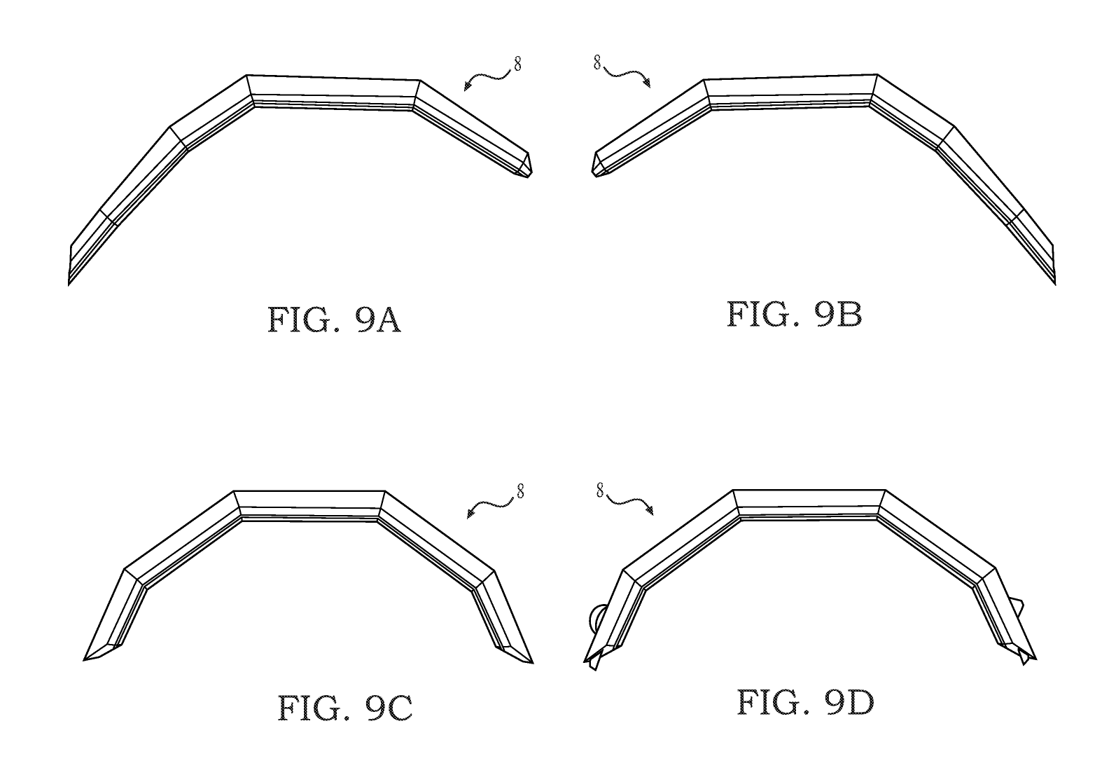

FIGS. 9A to 9D show one example of the fender flares 8. FIG. 9A shows the front driver-side fender flare 8. FIG. 9B shows the front passenger-side fender flare 8. FIG. 9C shows the rear driver-side fender flare 8. FIG. 9D shows the rear passenger-side fender flare 8.

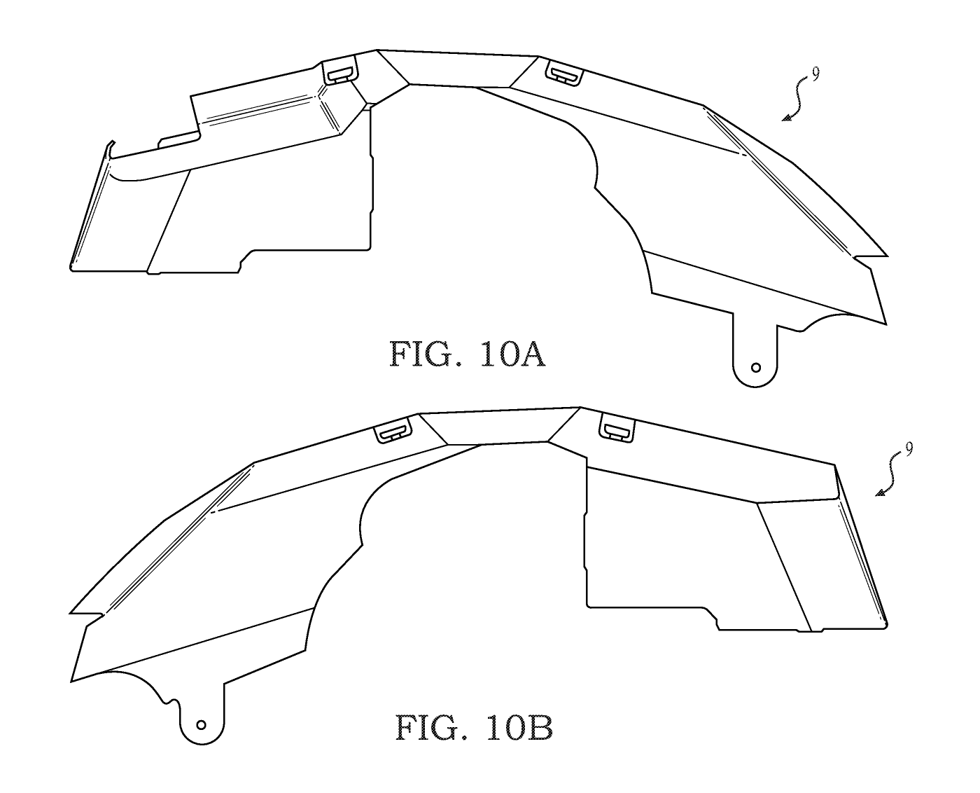

FIGS. 10A and 10B show the front inner fenders 9. FIG. 10A shows the driver-side inner fender 9. FIG. 10B shows the passenger-side inner fender 9.

Advantageously, each of the replacement vehicle body parts has a predetermined shape configured to match the cut, drilled, or otherwise modified surface of the vehicle body. In other words, as discussed in greater detail below, the vehicle body modification method employs the predetermined templates to create cut, drilled, or otherwise modified attachment surfaces or edges of the vehicle body with which the corresponding predetermined replacement vehicle body parts may mate.

(2) Vehicle Body Modification Method

(2-1) Step 1: Vehicle Part Removal

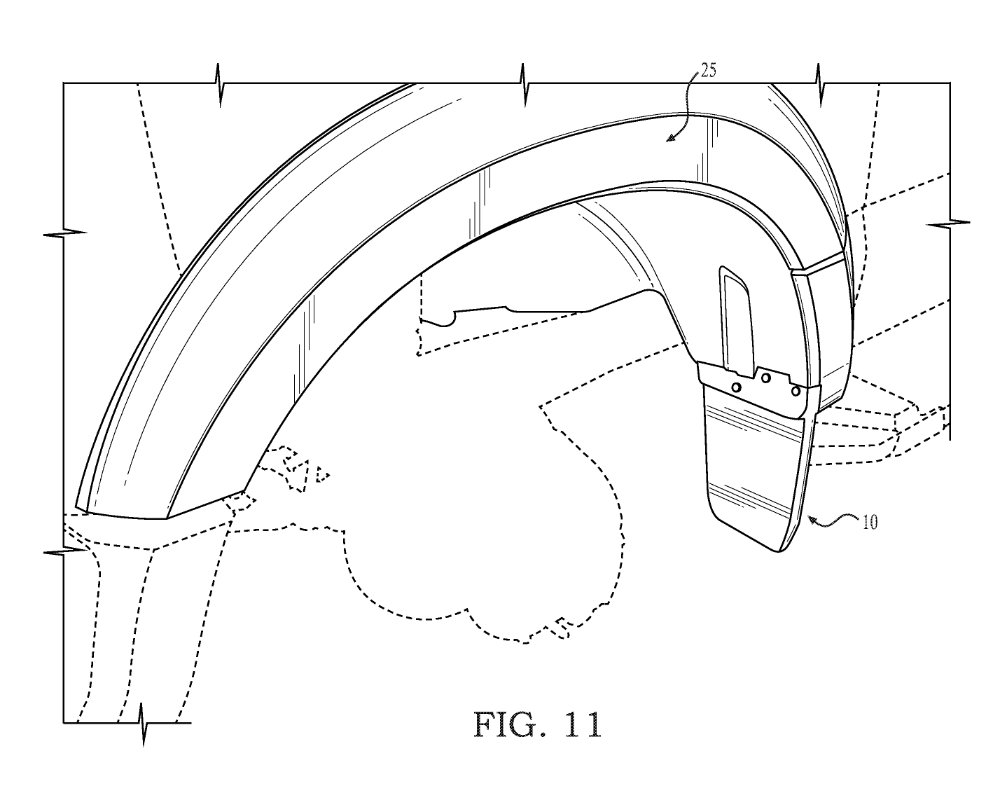

The vehicle body modification method will now be described with reference to FIGS. 11-61. As a first step S1 in the method, one or more vehicle parts may be removed, such as the radiator cover, the grille, the bumper and any other parts necessary for access to the fender and other vehicle body portions to be modified.

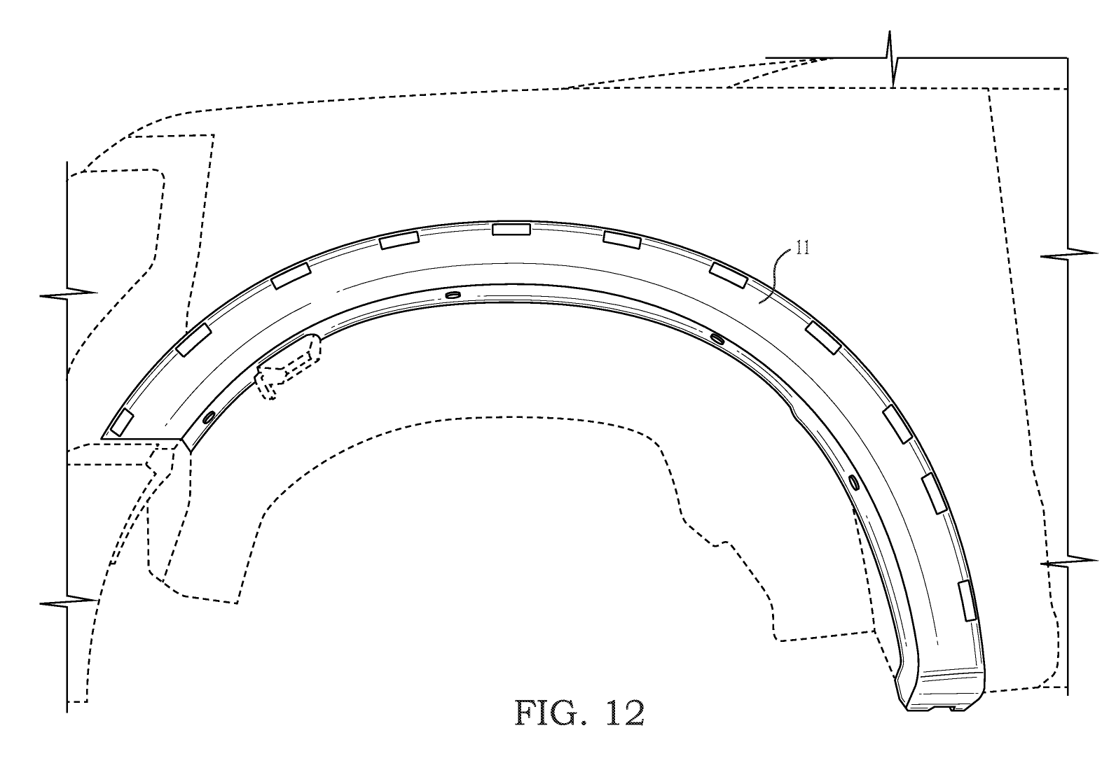

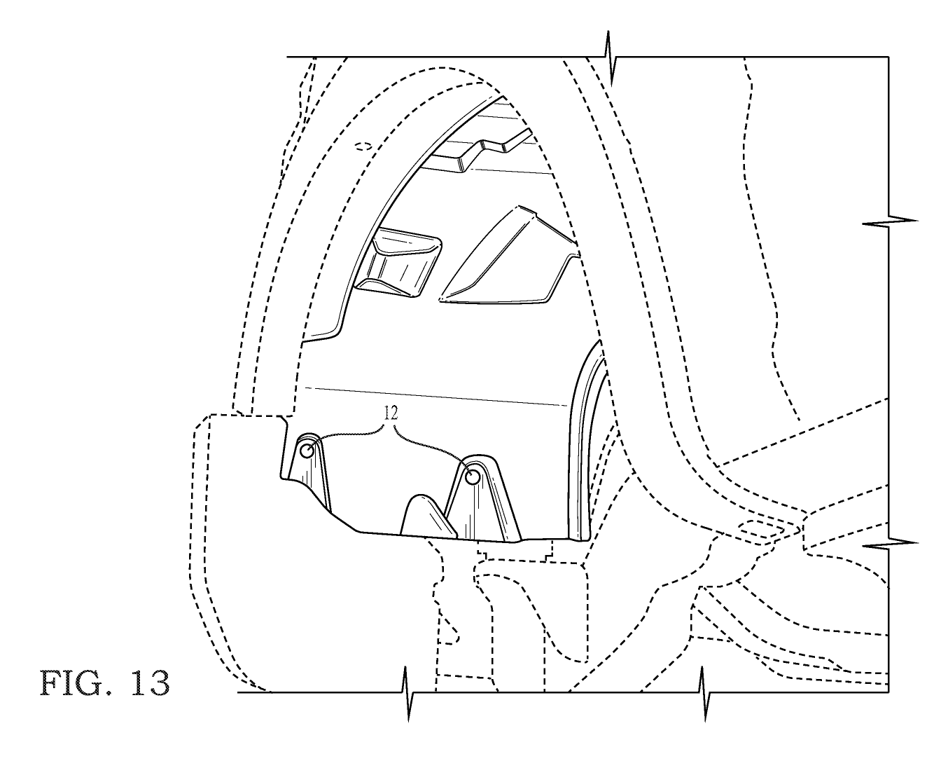

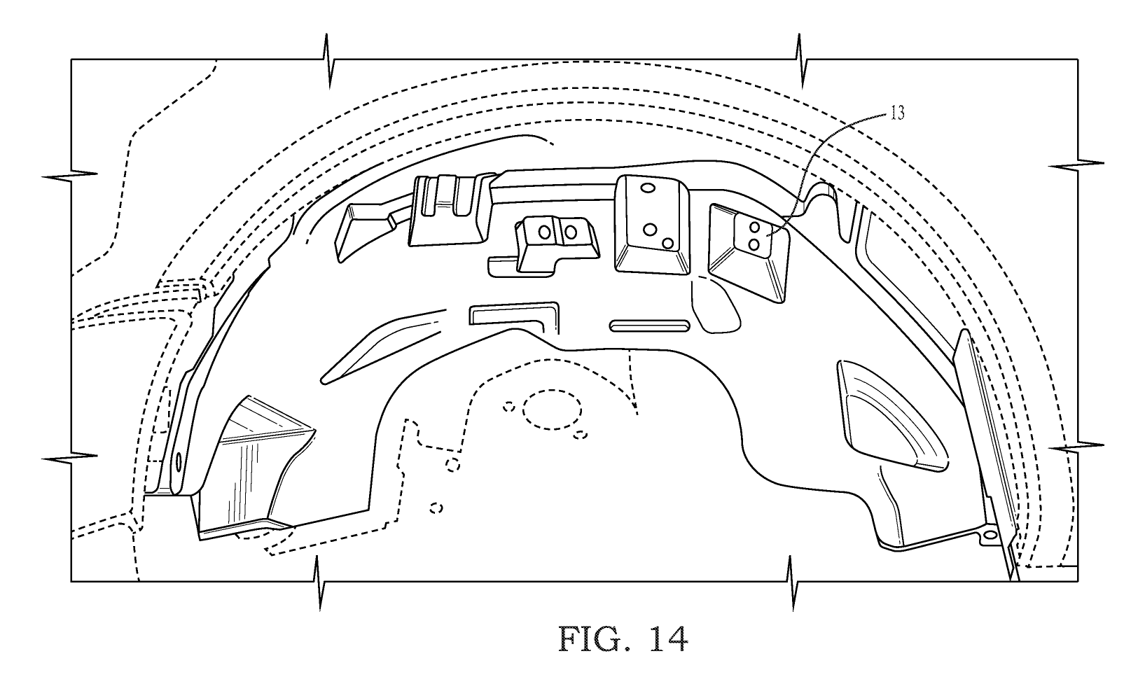

For example, as shown in FIG. 11, during trim removal at the front fender 25, the corner molding and mud flaps 10 may be removed on both sides of the vehicle. Then, as shown in FIG. 12, the trim 11 may then be removed from the fender 25. Then, as shown in FIG. 13, the inner fender/liner screws or pins 12 may be removed, followed by removal of the inner fender retainers 13 (FIG. 14). Of course, the vehicle parts to be removed are not limited to these, and the parts necessary to remove in the initial step will differ depending on the particular modification to be made and depending on the particular vehicle being modified.

(2-2) Step 2: Template Installation

Next, as a second step S2 in the method, the templates of FIG. 2 may be mounted to the surfaces of the vehicle 1. The second step S2 is performed on both the driver side and the passenger side of the vehicle 1. Thus, unless otherwise indicated, it should be assumed that any template installation performed on one of the driver and passenger sides of the vehicle 1 may be performed on the other of the driver and passenger sides of the vehicle 1.

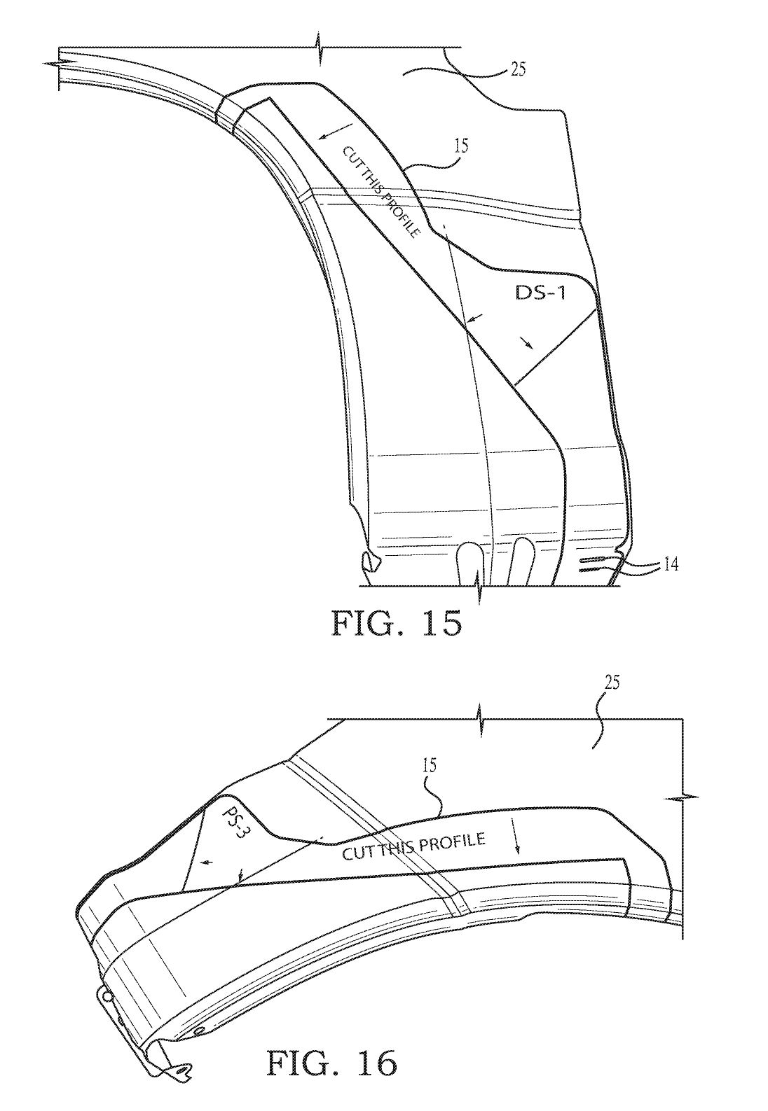

FIG. 15 shows the template DS-1 with which the driver-side fender 25 may be cut. The template DS-1 may be aligned with holes 14 on the bottom of the driver-side fender 25 and the outside contour 15 of the fender 25. As shown in FIG. 16, the template PS-3, which is a mirror image of the template DS-1, may be mounted on the passenger-side fender 25 and aligned with holes (not shown) on the bottom of the passenger-side fender 25 and the outside contour 15 of the fender 25.

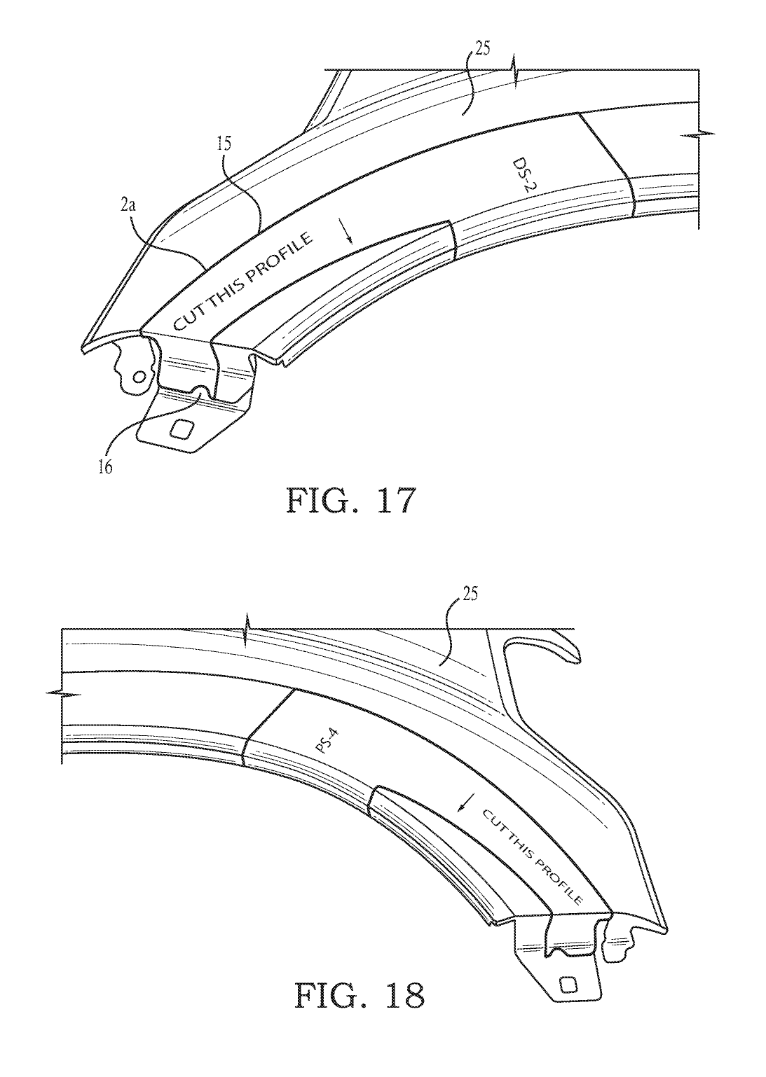

As seen in FIG. 17, a template DS-2 may be installed on the front bottom edge of the driver-side fender 25. The contour 2a of the template DS-2 is aligned with the contour 15 of the fender 25 as well as with the matching surface 16 of the fender 25. As shown in FIG. 18, a template PS-4, which is a mirror image of the template DS-2, may be mounted on the passenger-side fender 25 and aligned with the corresponding contours and surfaces of the passenger-side fender 25.

As understood from the figures, each of the plurality of templates has a predetermined shape that both matches (aligns with) the surface of the corresponding vehicle body portion to which it is to be installed, and also provides the cut, drill, or other modification lines for executing the modification of the fender. Moreover, as will be described further below in the method, each template includes a predetermined modification instruction to cut along an indicated cut profile, to drill within an indicated drill area, and/or execute some other operation for modifying the vehicle body.

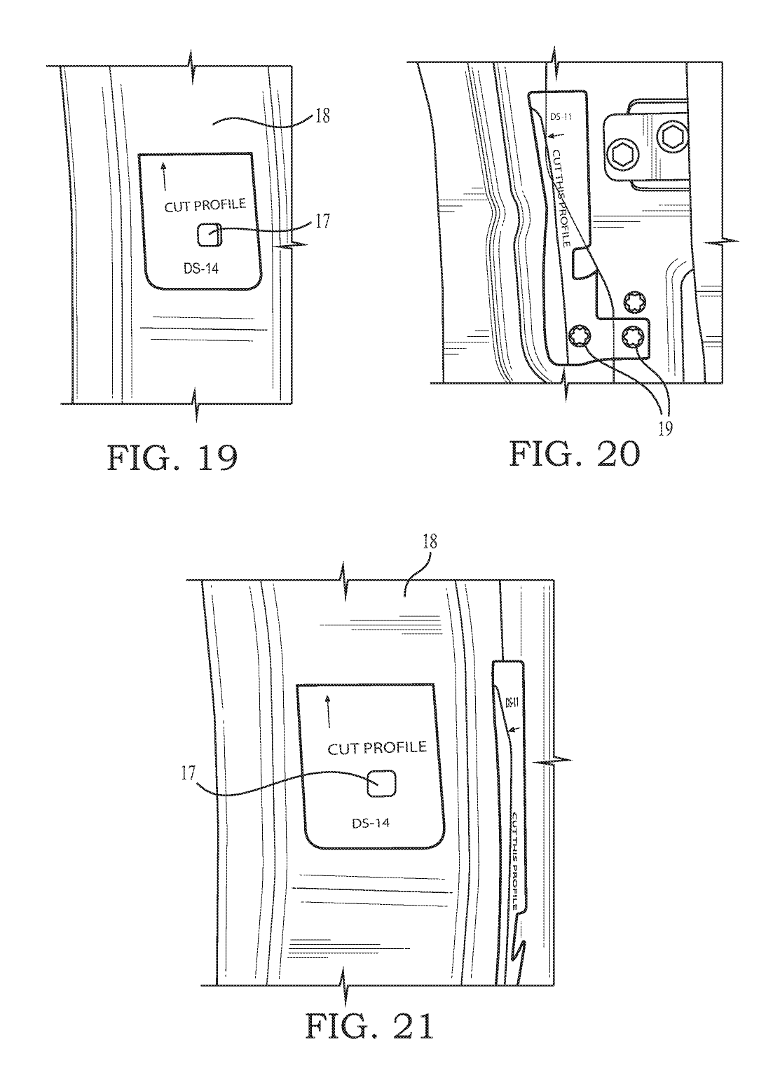

A template DS-14 may then be aligned with a square cut 17 in a driver-side vehicle rocker panel 18, as illustrated in FIG. 19. A template DS-11 may then be aligned with two bolts 19 in the side of the rocker panel 18 under door hinges (not shown), as seen in FIG. 20. When the templates DS-14 and DS-11 are both installed, the top of the cut profile 2b (indicated by the predetermined modification instruction 2c) of the template DS-11 will be aligned with the top of the cut profile 2b of the template DS-14, as understood from FIG. 21.

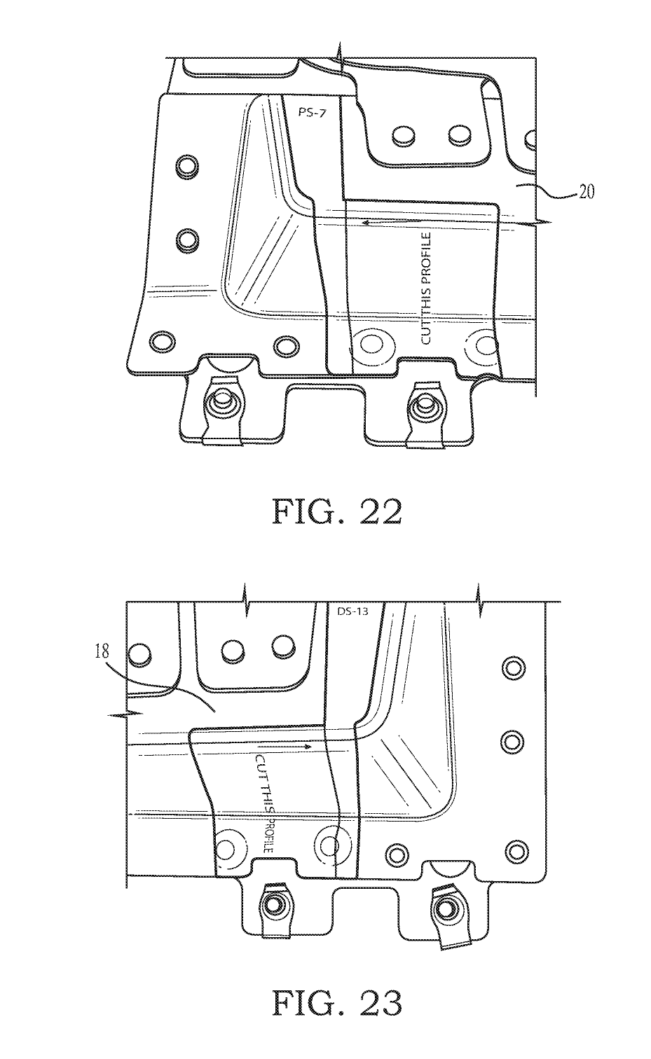

A template PS-7 may then be installed on the inside of a passenger-side rocker panel 20 such that the bottom of the template PS-7 aligns with the inside profile of the rocker panel 20, as seen in FIG. 22. Similarly, as shown in FIG. 23, a template DS-13 may be installed on the inside of the driver-side rocker panel 18 such that the bottom of the template DS-13 aligns with the inside profile of the rocker panel 18.

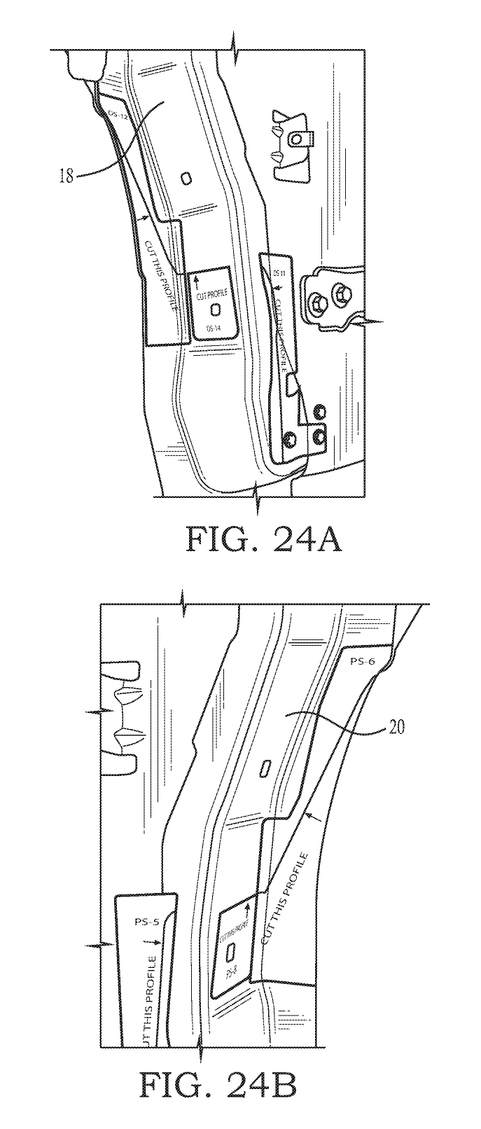

In FIG. 24A, the template DS-12 may then be installed by, as discussed above, matching the contour of the template DS-12 to the contour of the vehicle body. Once installed, the bottom of the cut profile 2b of the template DS-12 will be aligned with the top of the cut profile 2b of the template DS-11 and will also be aligned with the top of the cut profile 2b of the template DS-14, as seen in FIG. 24A.

Similarly, in FIG. 24B, the template PS-6 may then be installed by, as discussed above, matching the contour of the template PS-6 to the contour of the vehicle body. Once installed, the bottom of the cut profile 2b of the template PS-6 will be aligned with the top of the cut profile 2b of the template PS-5 and will also be aligned with the top of the cut profile 2b of the template PS-8, as seen in FIG. 24B.

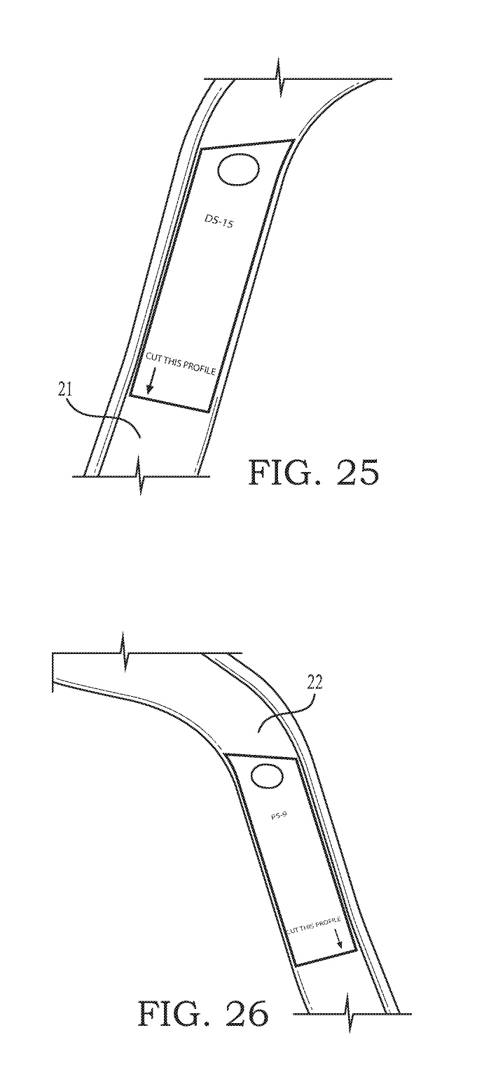

Next, as shown in FIG. 25, the template DS-15 may be installed on the driver-side reinforcement bar 21. Similarly, as seen in FIG. 26, the template PS-9 may be installed on the passenger-side reinforcement bar 22.

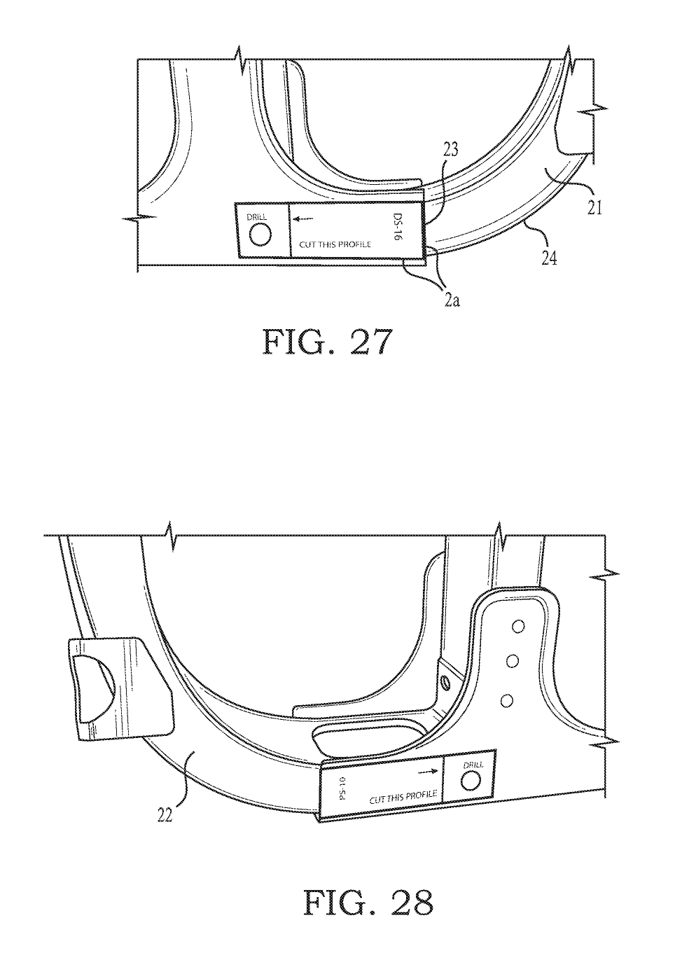

After that, the template DS-16, shown in FIG. 27, may be installed by aligning the side contour 2a of the template DS-16 with the edge 23 of the driver-side reinforcement bar 21, and aligning the bottom contour 2a of the template DS-16 with the bottom 24 of the reinforcement bar 21. The same may be done with a passenger-side template PS-10 at the passenger-side reinforcement bar 22, as seen in FIG. 28.

Although not described in detail herein, the vehicle body modification system may include additional templates, such as the four undesignated templates of FIG. 2 on which the modification instruction 2c “drill here” is inscribed. Additional templates such as these may be included as needed for the particular vehicle body modification.

It should be understood that the above template installations may be performed in a different order than that described above, as long as the templates align with the corresponding vehicle body portions, and as long as the cut profiles 2b of two or more templates align as needed (as discussed above with reference to FIGS. 24A and 24B). Also, it should be understood that any templates not required for the particular modification may be excluded, and any additional required templates may be added and installed, as needed. The vehicle body modification system is intended to be suitable for the particular vehicle model and modification. As mentioned above, the shapes and sizes used in the system and method are not to be interpreted as limiting this disclosure, as each vehicle model and/or modification design may have different shapes and sizes as needed.

(2-3) Step 3: Modifying Using the Templates

Next, as a third step S3 in the method, the vehicle body may be cut, drilled, and otherwise modified according to the predetermined modification instructions 2c shown on the installed templates. As with the template installation described above, the third step S3 is performed on both the driver side and the passenger side of the vehicle 1. Thus, unless otherwise indicated, it should be assumed that any cutting, drilling or other modification performed on one of the driver and passenger sides of the vehicle 1 may be performed on the other of the driver and passenger sides of the vehicle 1.

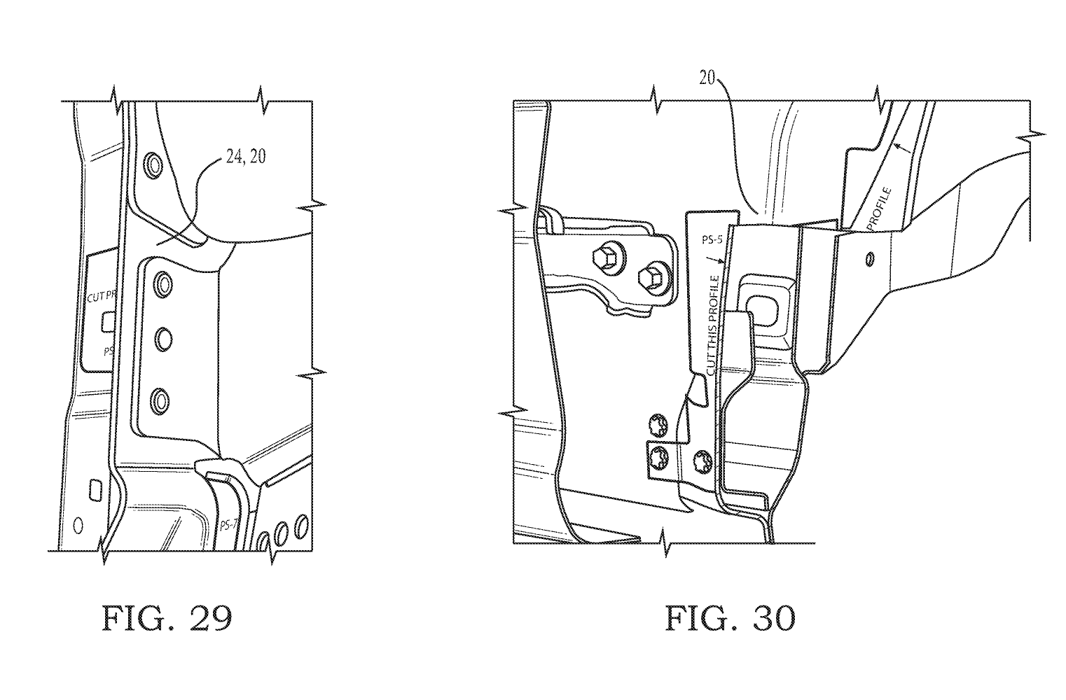

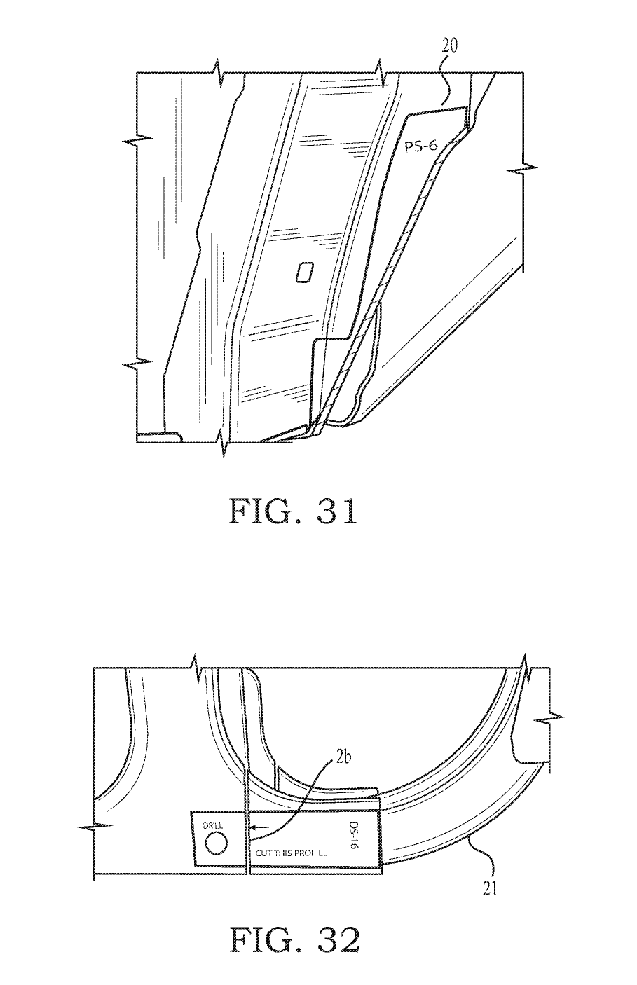

In the third step S3, first a flange 24 of the rocker panel 20 on the passenger side, shown in FIG. 29, may be cut along the cut profile 2b (indicated by the predetermined modification instruction 2c) of the template PS-8, shown in FIG. 24B. Next, the rocker panel 20 may be cut along the cut profile 2b of the template PS-5, starting from the bottom of the template PS-5 and cutting upward, leaving the rocker panel 20 as shown in FIG. 30. Next, the rocker panel 20 may be cut upward along the cut profile 2b of the template PS-6, as shown in FIG. 31.

These cutting operations may be repeated in a mirrored fashion using the driver-side templates. Specifically, the driver-side rocker panel 18 may be cut along the cut profiles 2b of the templates DS-14, DS-11 and DS-12.

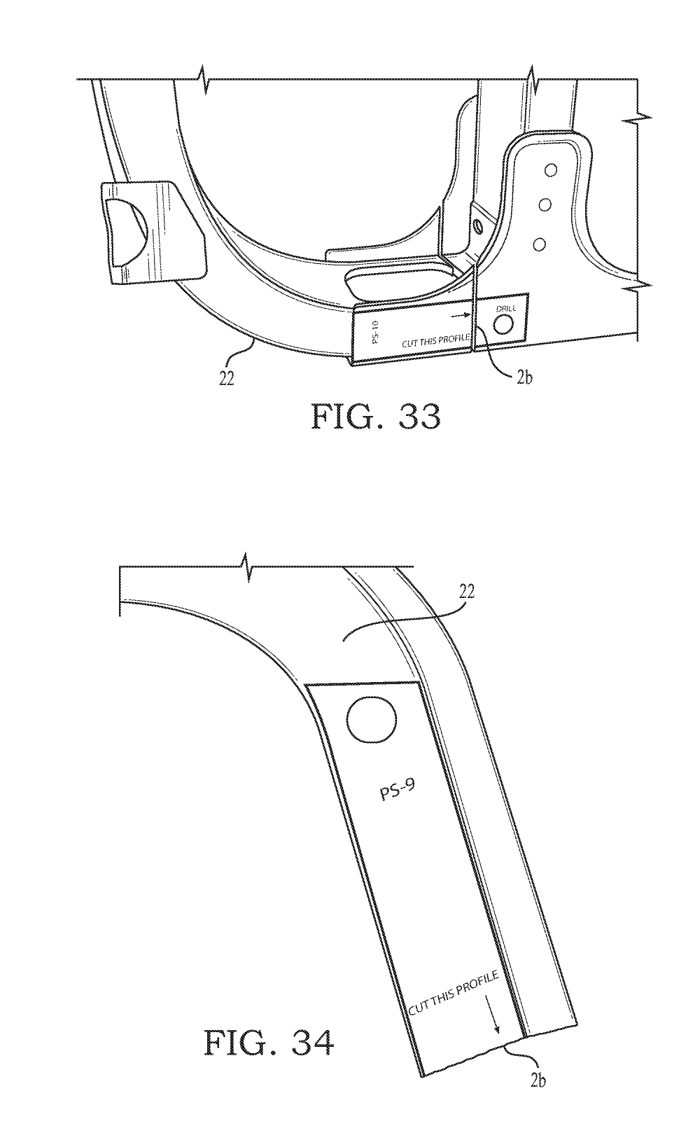

Next, the reinforcement bar (21, 22) may be cut using the templates DS-16, DS-15, PS-10 and PS-9. As shown in FIG. 32, the driver-side reinforcement bar 21 may be cut along the cut profile 2b of the template DS-16. As shown in FIG. 33, the passenger-side reinforcement bar 22 may be cut along the cut profile 2b of the template PS-10. And, as shown in FIG. 34, the reinforcement bar 22 may be cut along the cut profile 2b of the template PS-9. It should be noted that the same cutting operation may be performed along the template DS-15 after cutting along the cut profile 2b of the template DS-16.

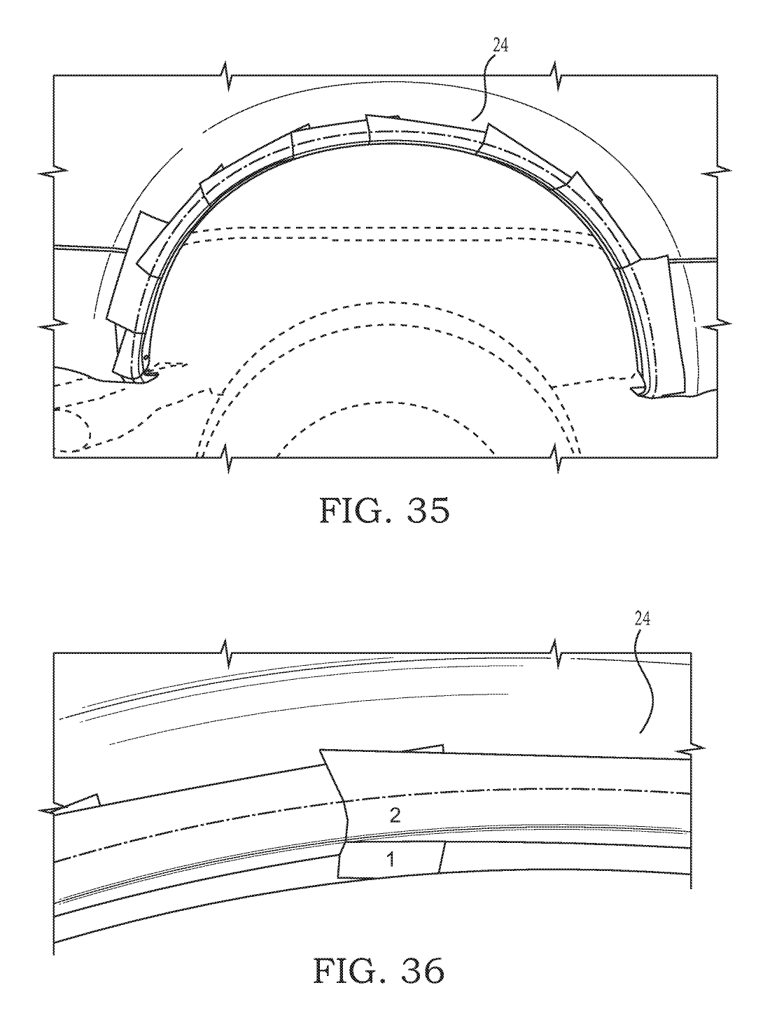

The driver-side and passenger-side bed may then be cut to remove the rear fenders 24. Specifically, as shown in FIG. 35, the rear fender 24 may be covered with painter's tape (or any similar method of marking) along the contour of the rear fender 24. The contour may be marked to indicate a cutting line, using, for example, numerals such as “1” and “2” shown in FIG. 36. The rear fender 24 may then be cut along the contour.

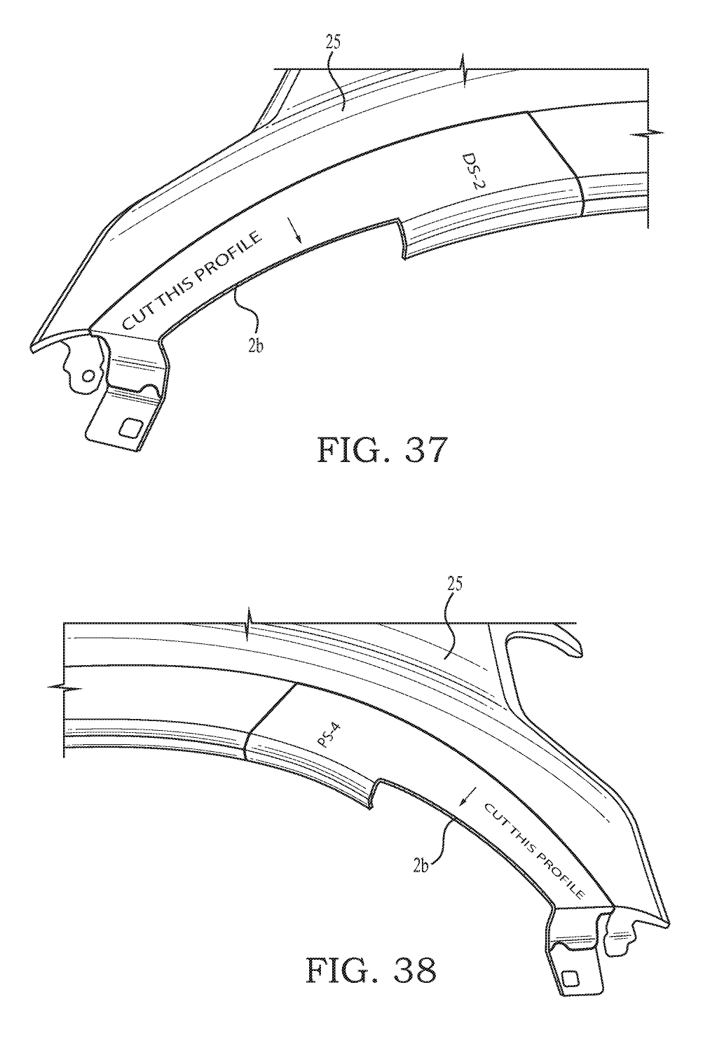

The front fenders 25 may then be cut using the templates installed as described above. As shown in FIG. 37, the lower front end section of the driver-side fender 25 may be cut along the cut profile 2b of the template DS-2. FIG. 37, which shows the fender 25 after having been cut along the cut profile 2b of the template DS-2, may be compared with FIG. 17, which shows the fender 25 before having been cut along the cut profile 2b of the template DS-2. FIG. 38 shows the mirror image operation performed on the passenger side along the cut profile 2b of the template PS-4 to remove the front end portion of the fender 25 shown in FIG. 18 prior to cutting.

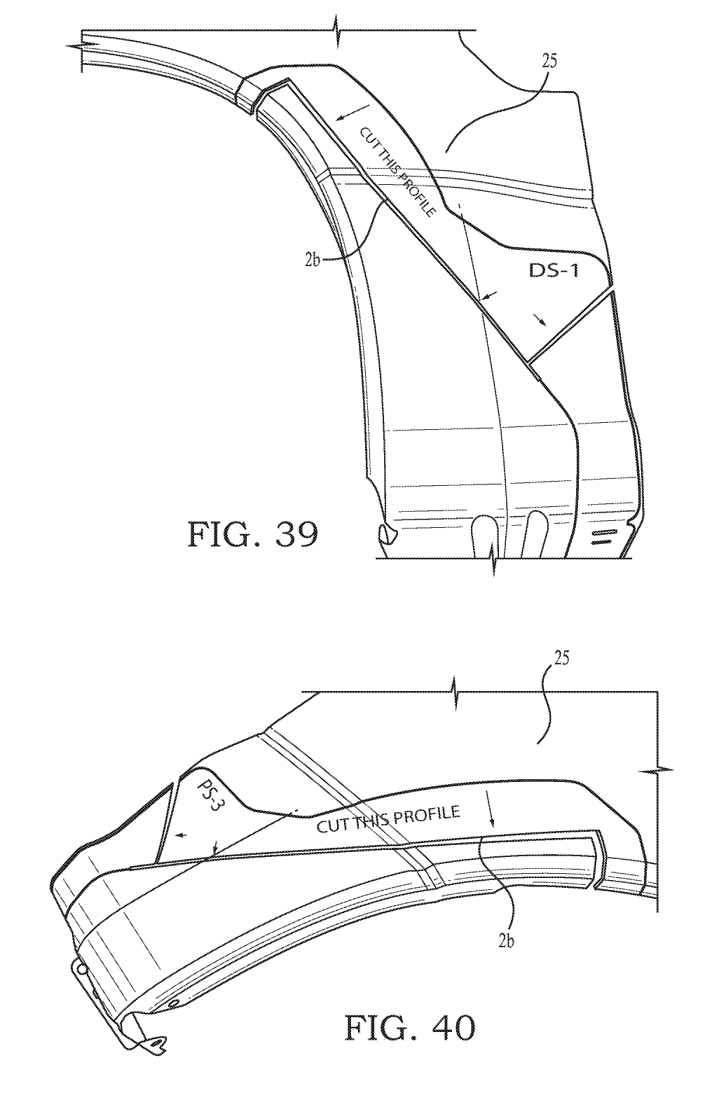

Next, the rear end portions of the front fenders 25 may be cut along the cut profiles 2b of the templates DS-1 and PS-3, as seen in FIGS. 39 and 40. These rear end portions are then removed.

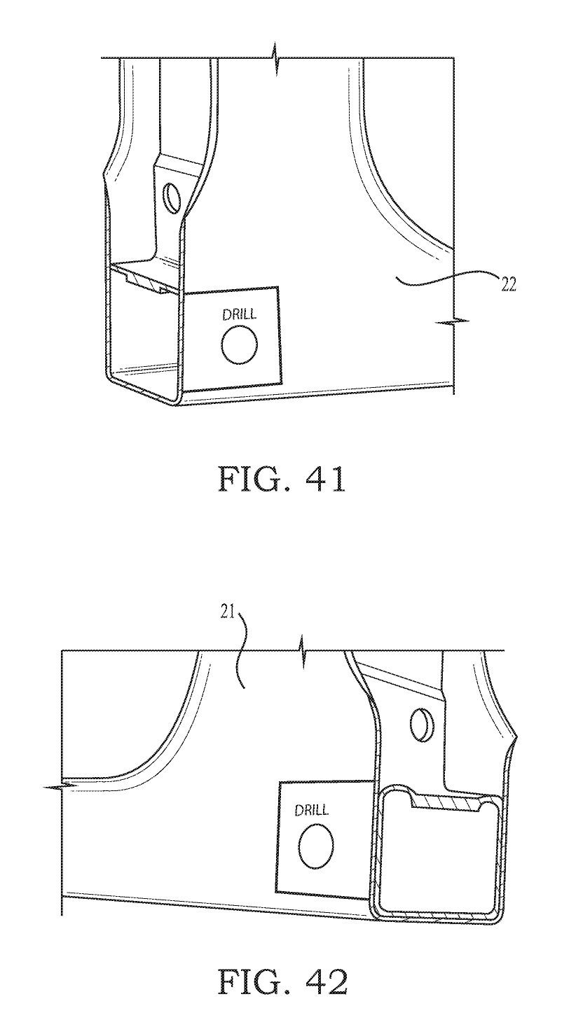

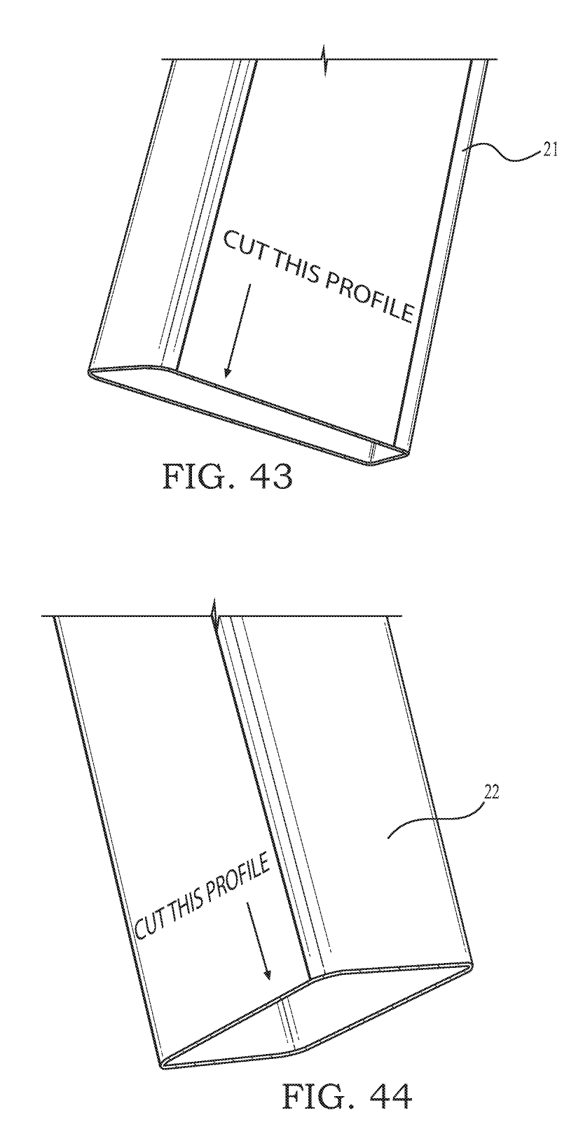

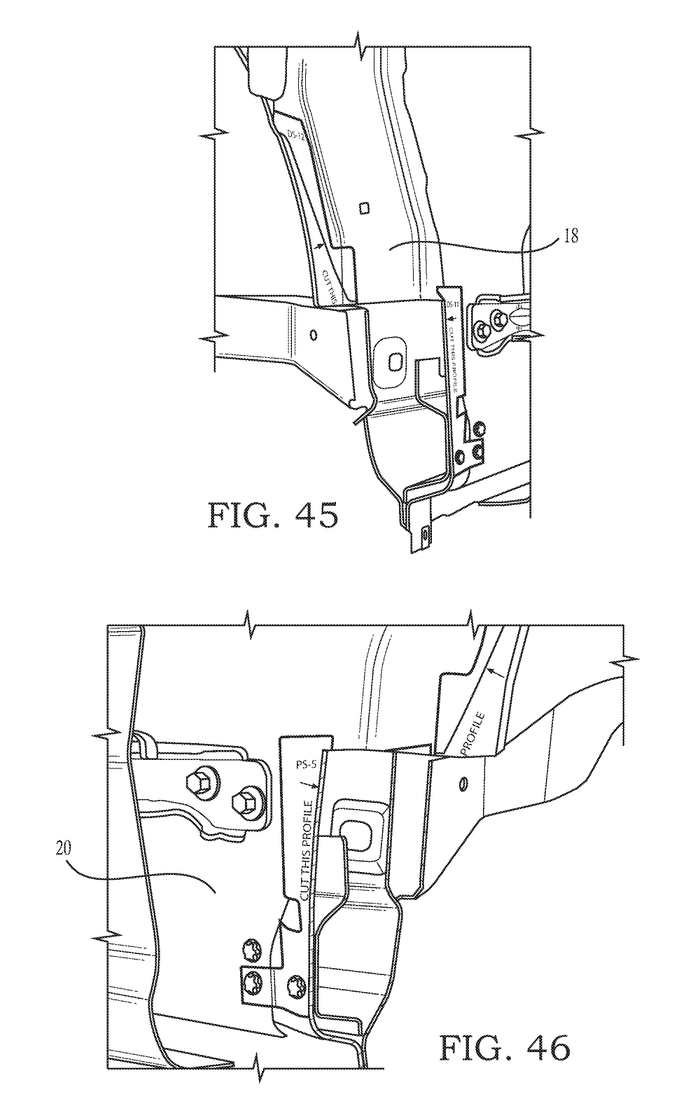

FIGS. 41 to 46 show examples of the vehicle body after the various cutting has been completed in the third step S3 in the method. Specifically, FIG. 41 is a view illustrating the passenger-side reinforcement bar 22 after being cut using the template PS-10. FIG. 42 is a view illustrating the driver-side reinforcement bar 21 after being cut using the template DS-16. FIG. 43 is a view illustrating the driver-side reinforcement bar 21 after being cut using the template DS-15. FIG. 44 is a view illustrating the passenger-side reinforcement bar 22 after being cut using the template PS-9. FIG. 45 is a view illustrating the driver-side vehicle rocker panel 18 after being cut using the templates DS-14 and DS-11. FIG. 46 is a view illustrating the passenger-side vehicle rocker panel 20 after being cut using the templates PS-8 and PS-5.

(2-4) Step 4: Installing Replacement Vehicle Body Parts

Next, as a fourth step S4 in the method, the aforementioned replacement vehicle body parts may be installed. As with the other steps of the method, the installation of these parts may be done in a different order, and the method is not limited to the following description of an exemplary embodiment.

The step of installing the replacement vehicle body parts described above and shown in FIGS. 3 to 10B will now be discussed. As will be seen in the figures described below, the shapes, sizes and cut profiles of the plurality of templates allow for the replacement vehicle body parts to mate securely with the cut surfaces of the vehicle body.

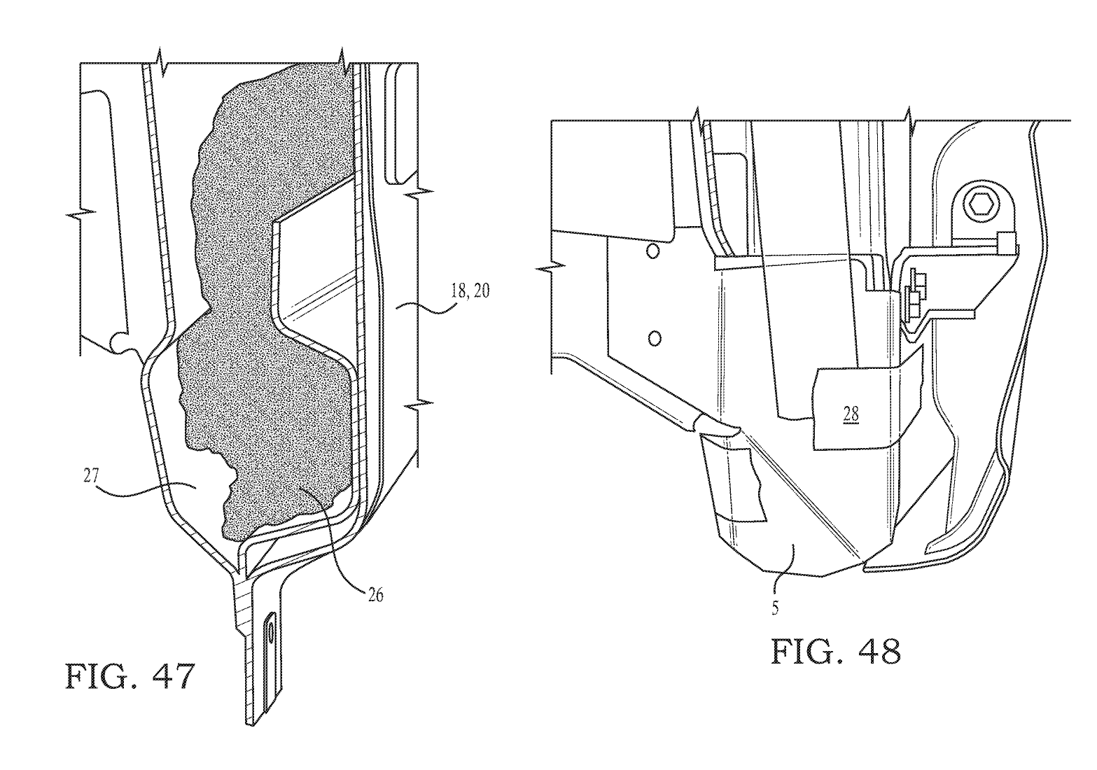

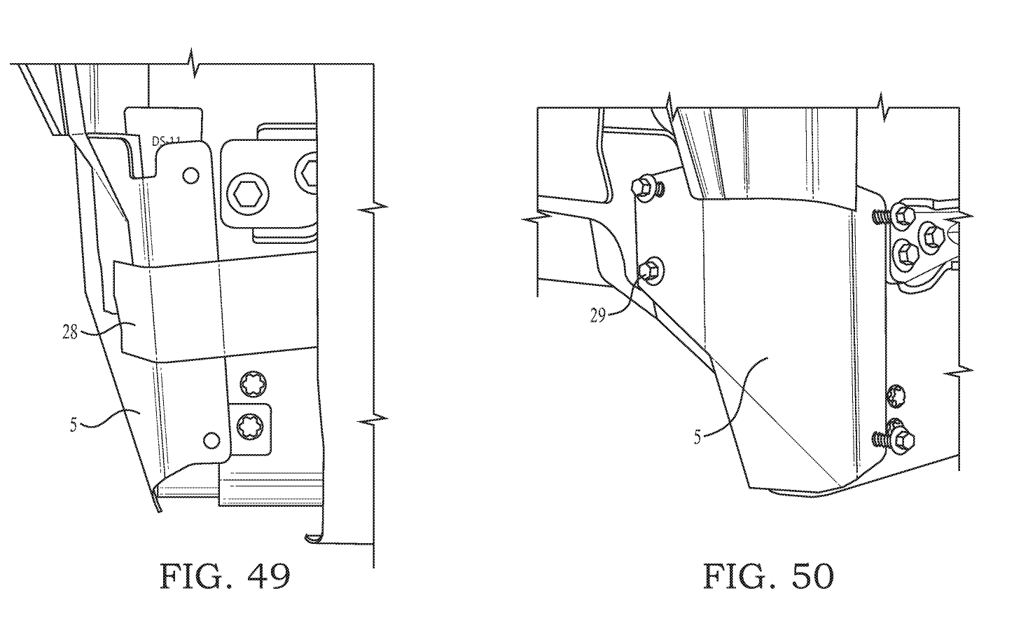

Installation of the cap plates 5 of FIGS. 6A and 7B for the rocker panels 18, 20 will be described with reference to FIGS. 47 to 50. FIG. 47 shows the rocker panel 18, 20 after being cut. As seen in FIG. 47, foam (e.g., OEM foam) 26 may be inserted into the open channel 27 of the rocker panel 18, 20. The cap plate 5 of FIGS. 6A and 7B may then be installed as seen in FIGS. 48 and 49 and secured with tape 28 or any other appropriate temporary means of securing. Then the cap plate 5 may be fully secured using a fastening means such as the bolts 29 shown in FIG. 50. The cap plates 5 may be installed in this manner on both the driver and passenger sides of the vehicle 1.

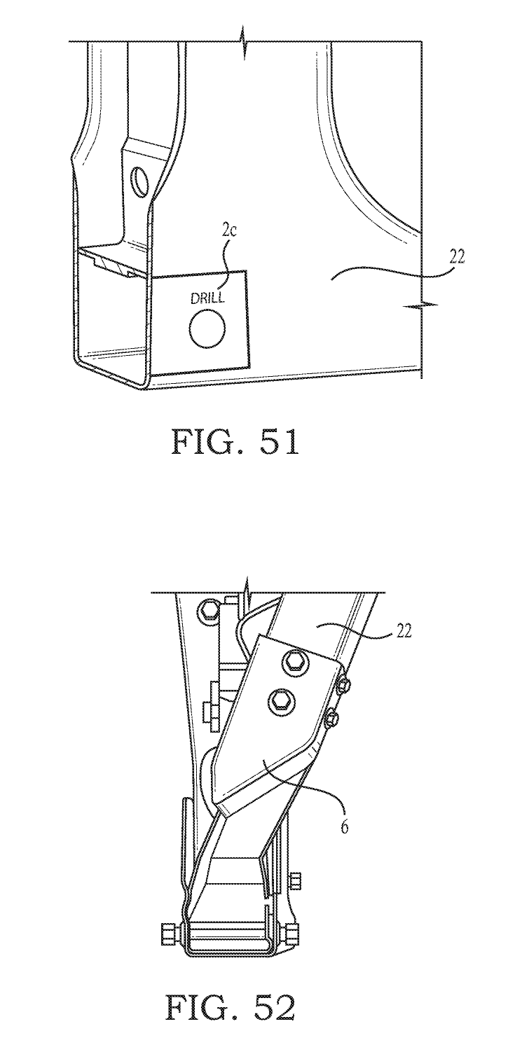

Installation of the reinforcement brackets 6 of FIGS. 6B and 7A for the reinforcement bars will be described with reference to FIGS. 51 and 52. FIG. 51 shows the reinforcement bar 22 after having been cut using the template PS-10. The modification instruction 2c “drill” is shown on the remainder of the template DS-16 in FIG. 51. A hole may be drilled into the reinforcement bar 22 at the location indicated by the modification instruction 2c. The reinforcement bracket 6 may then be installed to the cut surfaces of the reinforcement bar 22 as shown in FIG. 52, and a fastening means (e.g., a bolt) may be inserted through the drilled hole to secure the reinforcement bracket 6 to the reinforcement bar 22. The reinforcement brackets 6 may be installed in this manner on both the driver and passenger sides of the vehicle 1.

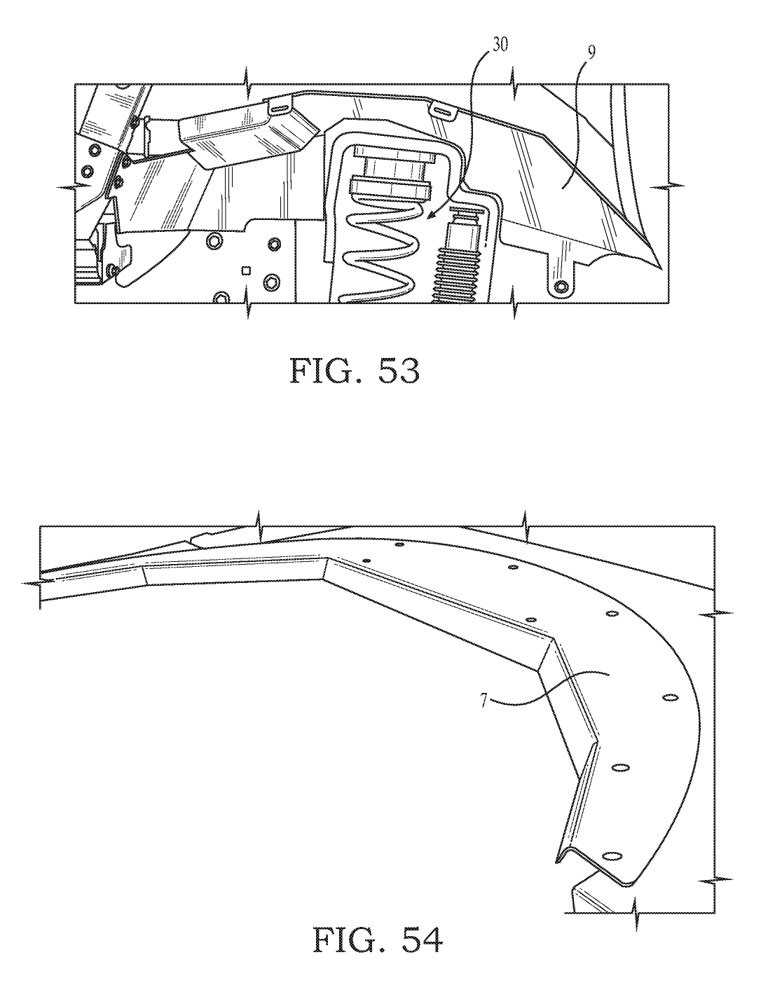

Installation of the inner fenders 9 of FIGS. 10A and 10B will be described with reference to FIG. 53. As shown in FIG. 53, each inner fender 9 may be installed flush against the vehicle frame using proper fastening means (not shown). The inner fender 9 is sized and shaped to avoid contact with the suspension means (e.g., the shock tower 30). The inner fenders 9 may be installed in this manner on both the driver and passenger sides of the vehicle 1.

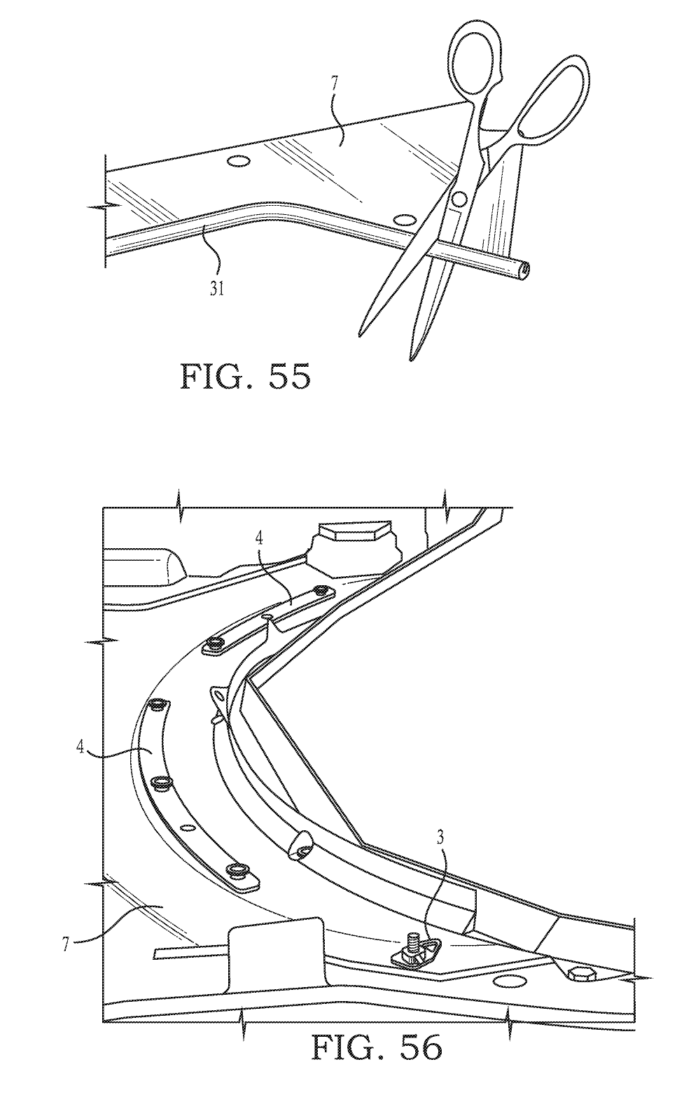

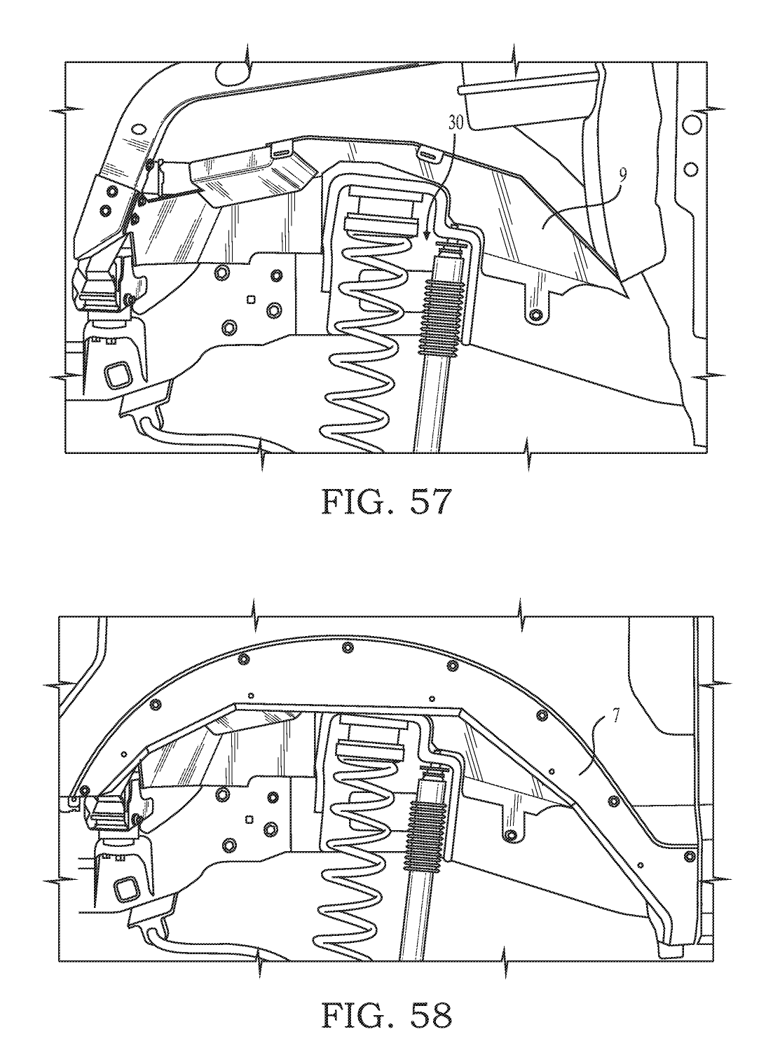

Installation of the fender bases 7 of FIGS. 8A to 8D will be described with reference to FIGS. 54 to 59. First, the front fender bases 7 of FIGS. 8A and 8B may be installed. The front fender base 7 may be drilled, provided with a sealing member 31, and otherwise prepared as needed, as shown in FIGS. 54 and 55. The mounting tabs 3 and mounting plates 4 of FIGS. 3 to 5 may be installed on the front fender base 7 as shown in FIG. 56. FIG. 57 indicates the state of the vehicle before the front fender base 7 is installed. As seen in FIG. 58, the front fender base 7 may then be installed flush with the cut surfaces of the fender which were cut using the templates as discussed above. The front fender bases 7 may be installed in this manner on both the driver and passenger sides of the vehicle 1.

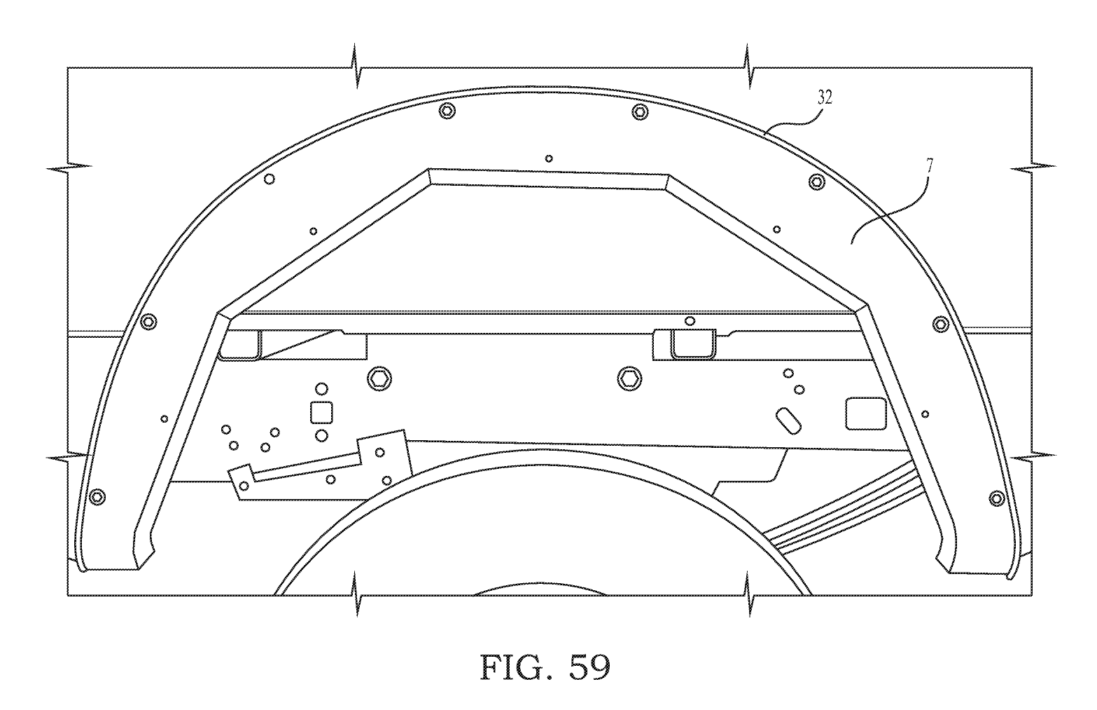

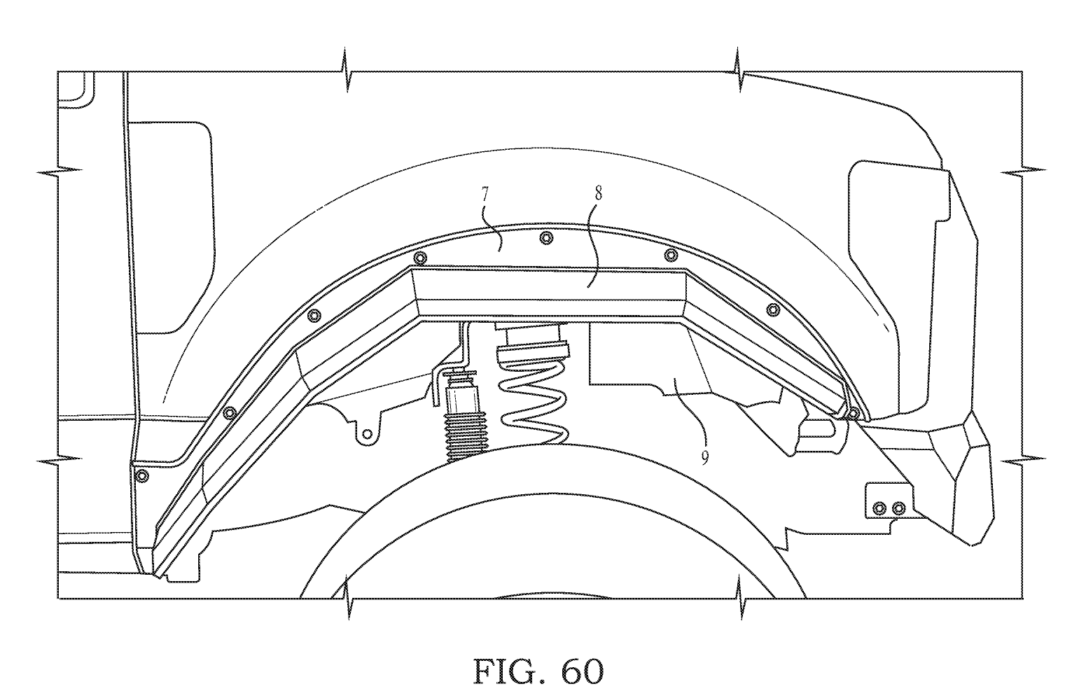

Next, the rear fender bases 7 of FIGS. 8C and 8D may be installed. The rear fender base 7 may be installed using appropriate fastening means. The rear fender base 7 may be lined with a sealing member 32 and installed as shown in FIG. 59, with the rear fender base 7 contacting and fitting flush against the cut surfaces of the fender. The rear fender bases 7 may be installed in this manner on both the driver and passenger sides of the vehicle 1.

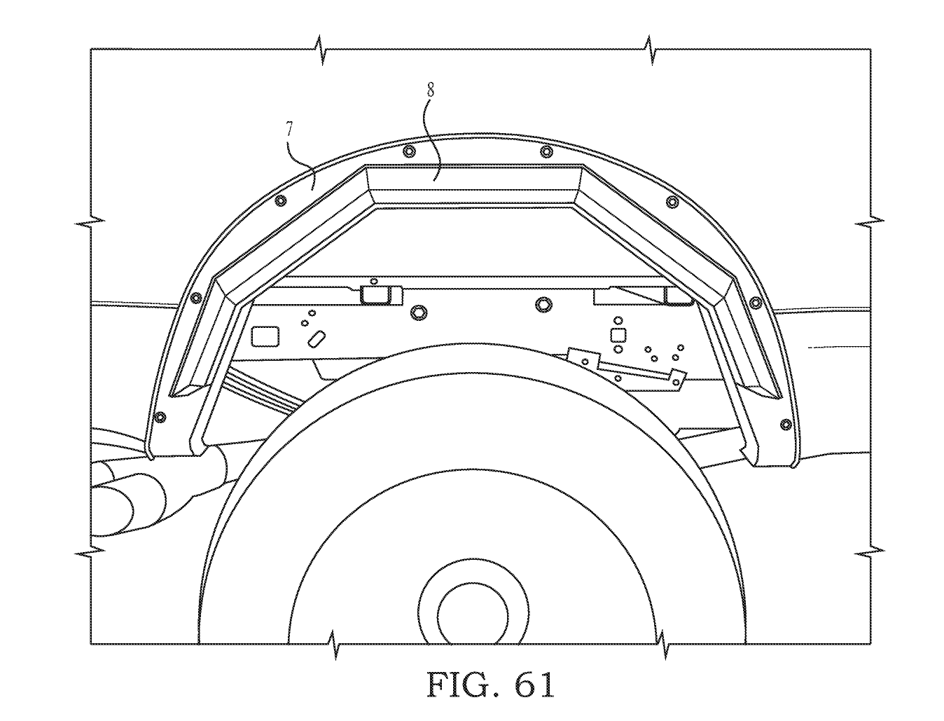

Installation of the fender flares 8 of FIGS. 9A to 9D will be described with reference to FIGS. 60 and 61. A sealing member (not shown) may be attached to a mounting edge of each fender flare 8, as needed. Then, using an appropriate attachment means (e.g., bolts), the front fender flares 8 may be attached as shown in FIG. 60, and the rear fender flares 8 may be attached as shown in FIG. 61.

(3) Advantageous Effects

The above-described vehicle body modification method provides a rapid, efficient, and less expensive way to modify a vehicle fender or other vehicle body portion. The method may be used with any package of templates to achieve any desired vehicle body modification for any model of vehicle. The inventive concepts relating to the disclosed method and templates are thus widely applicable to accommodate the needs of each vehicle owner.

Advantageously, due to the templates being shaped and sized in the predetermined manner discussed above, and also due to the cut profiles of the templates and other modification instruction being positioned in the predetermined manner on the templates, the templates allow for the resulting attachment surfaces or edges of the vehicle body to mate with corresponding surfaces or edges of the replacement vehicle body parts to form functioning wheel wells. In general, cutting the stock body of a vehicle such that the resulting attachment surfaces or edges perfectly match the corresponding surfaces or edges of the replacement vehicle body parts is a very complicated and difficult task to accomplish using sheet metal fabrication. The templates and corresponding replacement vehicle body parts envisioned by this application greatly reduce the time, labor, and expense required to modify a vehicle body. At the same time, the templates and corresponding replacement vehicle body parts of this application improve the resulting vehicle body modification by providing precise cut profiles and modification instruction which result in the aforementioned attachment surfaces or edges that mate precisely with the corresponding surfaces or edges of the replacement vehicle body parts. In other words, due to the attachment surfaces being formed using the templates of the vehicle body modification system, the replacement vehicle body parts are installed such that the wheels and tires of the vehicle do not contact the replacement vehicle body parts or otherwise interfere with turning, suspension or other functions of the vehicle. Thus, each attachment surface or edge mates with the surface or edge of the corresponding replacement vehicle body part to form at least a part of a wheel well so that the corresponding replacement vehicle body part when installed does not contact a wheel of the vehicle (1) in any orientation of the wheel as it is turned and (2) in any position of the wheel along a travel of the suspension from extension to compression.

Exemplary embodiments of the present invention have been described above. It should be noted that the above exemplary embodiments are merely examples and the present invention is not limited to the detailed embodiments. It should be understood that various changes and modifications to the embodiments described herein will be apparent to those skilled in the art. Such changes and modifications can be made without departing from the spirit and scope of the present disclosure and without diminishing its intended advantages. It is therefore intended that such changes and modifications be covered by this disclosure.

What is claimed is:

1. A vehicle body modification system comprising:
a plurality of templates; and
a plurality of replacement vehicle body parts, wherein
each template has a predetermined shape and a predetermined size such that a contour of each template matches a corresponding surface contour of a vehicle body of a vehicle, and
each template is configured to provide a predetermined modification instruction for modifying the vehicle body so as to form an attachment surface or edge for attaching a corresponding one of the replacement vehicle body parts.

2. The vehicle body modification system according to claim 1, wherein
each template is provided with a predetermined cut profile for cutting the vehicle body;
the predetermined modification instruction is to cut along the predetermined cut profile; and
the attachment surface or edge is formed by cutting the vehicle body along the predetermined cut profile.

3. The vehicle body modification system according to claim 1, wherein
each template is configured such that the attachment surface or edge mates with a surface or edge of the corresponding one of the plurality of replacement vehicle body parts.

4. The vehicle body modification system according to claim 3, wherein
the attachment surface or edge mates with the surface or edge of the corresponding one of the plurality of replacement vehicle body parts to form at least a part of a wheel well so that the corresponding one of the plurality of replacement vehicle body parts when installed does not contact a wheel of the vehicle (1) in any orientation of the wheel as it is turned and (2) in any position of the wheel along a travel of the suspension from extension to compression.

5. The vehicle body modification system according to claim 1, wherein
the plurality of templates includes a first set of templates for a driver side of the vehicle and a second set of templates for a passenger side of the vehicle.

6. The vehicle body modification system according to claim 5, wherein
the predetermined shape and the predetermined size are different for each template of the first set of templates; and
the predetermined shape and the predetermined size are different for each template of the second set of templates.

7. The vehicle body modification system according to claim 6, wherein
each template of the first set of templates has a mirror-image template in the second set of templates.

8. The vehicle body modification system according to claim 1, wherein
the plurality of replacement vehicle body parts includes at least two of the group consisting of an inner fender, a fender base, a fender flare, a reinforcement bracket, and a cap plate.

9. The vehicle body modification system according to claim 1, wherein
the plurality of replacement vehicle body parts is provided for a driver side of the vehicle and a passenger side of the vehicle.

10. A vehicle body modification method comprising:
providing a plurality of templates and a plurality of replacement vehicle body parts, each template having a predetermined shape and a predetermined size;
removing one or more vehicle parts of a vehicle body of a vehicle;
installing the plurality of templates on the vehicle body such that a contour of each template matches a corresponding surface contour of the vehicle body; and
modifying the vehicle body based on a predetermined modification instruction for modifying the vehicle body, the predetermined modification instruction being provided by each of the plurality of templates.

11. The vehicle body modification method according to claim 10, wherein
the modifying of the vehicle body forms an attachment surface or edge for attaching a corresponding one of the replacement vehicle body parts.

12. The vehicle body modification method according to claim 10, wherein
the predetermined modification instruction is to cut along a predetermined cut profile provided to each template; and
the modifying of the vehicle body forms an attachment surface or edge for attaching a corresponding one of the replacement vehicle body parts by cutting the vehicle body along the predetermined cut profile.

13. The vehicle body modification method according to claim 11, further comprising
mating the attachment surface or edge with a surface or edge of a corresponding one of the plurality of replacement vehicle body parts.

14. The vehicle body modification method according to claim 13, wherein
the mating of the attachment surface or edge with the surface or edge of the corresponding one of the plurality of replacement vehicle body parts forms at least a part of a wheel well so that the corresponding one of the plurality of replacement vehicle body parts when installed does not contact a wheel of the vehicle (1) in any orientation of the wheel as it is turned and (2) in any position of the wheel along a travel of the suspension from extension to compression.

15. The vehicle body modification method according to claim 10, wherein
the installing of the plurality of templates includes installing a first set of templates on a driver side of the vehicle and installing a second set of templates on a passenger side of the vehicle; and
the modifying of the vehicle body includes modifying the driver side of the vehicle based on the first set of templates and modifying the passenger side of the vehicle based on the second set of templates.
